(19) United States
(12) Patent Application Publication
(10) Pub. No.: US 2017/0011434 A1
(43) Pub. Date: Jan. 12, 2017

(54) Ornament and Associated Systems and Methods

(71) Applicant: Jeffrey Goria, New York, NY (US)

(72) Inventor: Jeffrey Goria, New York, NY (US)

(21) Appl. No.: 15/205,299

(22) Filed: Jul. 8, 2016

Related U.S. Application Data
(60) Provisional application No. 62/189,996, filed on Jul. 8, 2015.

(51) Int. Cl. G06Q 30/02; G06F 3/0484; G08B 5/22; H04W 4/14; G06F 17/30; G06F 3/0481; H04L 29/08

(52) U.S. Cl. CPC G06Q 30/0277; G06F 3/0481; G06F 3/0484; H04L 67/10; H04W 4/14; H04L 67/26; G06F 17/30477; G08B 5/225

(57) ABSTRACT

Exemplary embodiments are directed to systems and methods of interacting with an ornament. Exemplary embodiments can establish a communication network between an ornament, a first user interface including a first graphical user interface, and a second user interface including a second graphical user interface. Exemplary embodiments can execute a messaging function at the second graphical user interface to generate and send a first message from the second user interface to the first user interface. Exemplary embodiments can, upon sending the first message to the first user interface, transmit a signal to the ornament to actuate a visual indicator of the ornament in a first color scheme or pattern to indicate that the first message has been sent to the first user interface.

### CROSS-REFERENCE TO RELATED APPLICATIONS

This application claims the benefit of co-pending U.S. Provisional Patent Application No. 62/189,996, filed on Jul. 8, 2015, the entire contents of which are incorporated herein by reference.

### TECHNICAL FIELD

The present disclosure relates to an ornament and associated systems and methods and, in particular, to an interactive ornament that receives communication from one or more users and provides feedback to the one or more users.

### BACKGROUND

Ornaments, along with garland, tinsel and lights, have been used to decorate Christmas trees for centuries. Traditionally, decoration of the Christmas tree with ornaments occurs near the beginning of the holiday season. Although ornaments serve a decorative function throughout the holiday season, there is generally little or no further interaction between the users (e.g., parents, children, or both) and the ornaments until the end of the holiday season. In particular, although ornaments come in a variety of shapes and sizes, traditional ornaments generally do not provide interactive features.

Thus, a need exists for interactive ornaments that receive communication from one or more users and provide feedback to the one or more users. These and other needs are addressed by the ornaments and associated systems and methods of the present disclosure.

### SUMMARY OF THE INVENTION

In accordance with embodiments of the present disclosure, exemplary methods of interacting with an ornament are provided. The methods include establishing a communication network between an ornament, a first user interface including a first graphical user interface, and a second user interface including a second graphical user interface. The methods include executing a messaging function with a messaging engine at the second graphical user interface to generate and send a first message from the second user interface to the first user interface. The methods include, upon sending the first message to the first user interface, transmitting a signal to the ornament to actuate at least one of a one or more visual indicators of the ornament in a first color scheme and/or pattern to indicate that the first message has been sent to the first user interface.

The methods can include opening the first message at the first graphical user interface of the first user interface and transmitting a signal to the ornament to actuate at least one of the plurality of visual indicators of the ornament in a second color scheme and/or pattern, the second color scheme and/or pattern being different from the first color scheme and/or pattern. The methods can include executing a messaging function with a messaging engine or generator at the first graphical user interface to generate and send a second message in response to the first message from the first user interface to the second user interface. The methods can include, upon receiving the second message at the second user interface, transmitting a signal to the ornament to actuate at least one of the plurality of visual indicators of the ornament in a third color scheme and/or pattern to indicate that the second message has been received by the second user interface. The third color scheme and/or pattern can be different from the first and second color schemes and/or patterns.

The methods can include executing a scheduling function with a scheduling engine that receives as input an indicator actuation preference and that outputs a visual indicator actuation of the plurality of visual indicators of the ornament based on the indicator actuation preference. The indicator actuation preference can be at least one of a manual actuation of the plurality of visual indicators of the ornament or a timer schedule for actuation of the plurality of visual indicators of the ornament. The methods can include executing a tracking function with a tracking engine that receives as input an indicator actuation preference and that outputs a visual indicator actuation of at least one of the plurality of visual indicators of the ornament in a fourth color scheme and/or pattern during a predetermined day and time specified in the indicator actuation preference. The fourth color scheme and/or pattern can be different from the first, second and third color schemes and/or patterns. The tracking function can be used to indicate the proximity or location of Santa Claus to the house and/or when Santa Claus is delivery gifts to the house.

The methods can include storing the first message in a messages database. In some embodiments, the methods can include constructing a database query to retrieve gift-related data from the messages database. In some embodiments, the methods can include executing a gift function that receives as input the gift-related data and that outputs a retailer link (e.g., a hyperlink) or an advertisement for purchasing a product corresponding to the gift-related data. In some embodiments, the methods can include executing a data collection function that receives as input the gift-related data and that outputs a communication to at least one retailer or manufacturer including the gift-related data.

In accordance with embodiments of the present disclosure, exemplary non-transitory computer-readable medium storing instructions that are executable by a processing device are provided. Execution of the instructions by the processing device can cause the processing device to establish a communication network between an ornament, a first user interface including a first graphical user interface, and a second user interface including a second graphical user interface. Execution of the instructions by the processing device can cause the processing device to execute a messaging function at the second graphical user interface to generate and send a first message from the second user interface to the first user interface. Execution of the instructions by the processing device can cause the processing device to, upon sending the first message to the first user interface, transmit a signal to the ornament to actuate at least one of a plurality of visual indicators of the ornament in a first color scheme and/or pattern to indicate that the first message has been sent to the first user interface.

Execution of the instructions by the processing device can cause the processing device to transmit a signal to the ornament to actuate at least one of the plurality of visual indicators of the ornament in a second color scheme and/or pattern when the first message is opened at the first graphical user interface. Execution of the instructions by the processing device can cause the processing device to execute a messaging function at the first graphical user interface to generate and send a second message in response to the first message from the first user interface to the second user interface. Upon receiving the second message at the second user interface, execution of the instructions by the processing device can cause the processing device to transmit a signal to the ornament to actuate at least one of the plurality of visual indicators of the ornament in a third color scheme and/or pattern to indicate that the second message has been received by the second user interface.

Execution of the instructions by the processing device can cause the processing device to execute a scheduling function that receives as input an indicator actuation preference and that outputs a visual indicator actuation based on the indicator actuation preference. Execution of the instructions by the processing device can cause the processing device to store the first message in a messages database. Execution of the instructions by the processing device can cause the processing device to construct a database query to retrieve gift-related data from the messages database. Execution of the instructions by the processing device can cause the processing device to execute a gift function that receives as input the gift-related data and that outputs a retailer link (e.g., a hyperlink) or advertisement for purchasing a product corresponding to the gift-related data.

In accordance with embodiments of the present disclosure, exemplary systems of interacting with an ornament are provided. The systems include an ornament, a first user interface, and a second user interface. The first user interface can include a first graphical user interface, a first non-transitory computer-readable medium, and a first processing device. The second user interface can include a second graphical user interface, a second non-transitory computer-readable medium, and a second processing device. In some embodiments, the first and second user interfaces can be access through a single device, e.g., a single smart phone, by using different username and password information.

The second processing device can be configured to execute instructions stored in the second non-transitory computer-readable medium to establish a communication network between the ornament, the first user interface, and the second user interface. The second processing device can be configured to execute instructions stored in the second non-transitory computer-readable medium to execute a messaging function at the second graphical user interface to generate and send a first message from the second user interface to the first user interface. Upon sending the first message to the first user interface, the second processing device can be configured to execute instructions stored in the second non-transitory computer-readable medium to transmit a signal to the ornament to actuate at least one of a plurality of visual indicators of the ornament in a first color scheme and/or pattern to indicate that the first message has been sent to the first user interface.

The first processing device can be configured to execute instructions stored in the first non-transitory computer-readable medium to open the first message at the first graphical user interface of the first user interface and, upon opening the first message at the first graphical user interface, transmit a signal to the ornament to actuate at least one of the plurality of visual indicators of the ornament in a second color scheme and/or pattern. The first processing device can be configured to execute instructions stored in the first non-transitory computer-readable medium to execute a messaging function at the first graphical user interface to generate and send a second message in response to the first message from the first user interface to the second user interface. Upon receiving the second message at the second user interface, the second processing device can be configured to execute instructions stored in the second non-transitory computer-readable medium to transmit a signal to the ornament to actuate at least one of the plurality of visual indicators of the ornament in a third color scheme and/or pattern to indicate that the second message has been received by the second user interface.

The first processing device can be configured to execute instructions stored in the first non-transitory computer-readable medium to store the first message in a messages database. The first processing device can be configured to execute instructions stored in the first non-transitory computer-readable medium to construct a database query to retrieve gift-related data from the messages database. The first processing device can be configured to execute instructions stored in the first non-transitory computer-readable medium to execute a gift function that receives as input the gift-related data and that outputs a retailer link or advertisement for purchasing a product corresponding to the gift-related data.

In accordance with embodiments of the present disclosure, exemplary ornaments are provided that include an ornament housing and a plurality of visual indicators disposed at least partially within the ornament housing. At least one of the plurality of visual indicators can be configured to be actuated based on messages received or sent between a first user interface and a second user interface. The ornament housing can include a printed circuit board disposed therein and programmed to actuate the plurality of visual indicators based on messages received or sent between the first user interface and the second user interface. The ornament can be in wireless communication with the first and second user interfaces. The exemplary ornaments and associated systems and methods therefore provide an interactive means of communicating with an ornament and receiving feedback from the ornament regarding the communications.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

The foregoing features of the invention will be apparent from the following Detailed Description, taken in connection with the accompanying drawings, in which:

FIG. 1 is a block diagram of an ornament system in accordance with exemplary embodiments of the present disclosure.

FIG. 2 is a block diagram of an ornament of an ornament system in accordance with embodiments of the present disclosure.

FIG. 3 is a block diagram of a database of an ornament in accordance with embodiments of the present disclosure.

FIG. 4 is a block diagram of a first user interface of an ornament system in accordance with embodiments of the present disclosure.

FIG. 5 is a block diagram of a second user interface of an ornament system in accordance with embodiments of the present disclosure.

FIG. 6 is a block diagram of a notification engine of an ornament in accordance with embodiments of the present disclosure.

FIG. 7 is a block diagram of a messaging engine of a first user interface in accordance with embodiments of the present disclosure.

FIG. 8 is a block diagram of a scheduling engine of a first user interface in accordance with embodiments of the present disclosure.

FIG. 9 is a block diagram of a gift engine of a first user interface in accordance with embodiments of the present disclosure.

FIG. 10 is a block diagram of a tracking engine of a first user interface in accordance with embodiments of the present disclosure.

FIG. 11 is a block diagram of an advertising engine of a first user interface in accordance with embodiments of the present disclosure.

FIG. 12 is a block diagram of a data collection engine of a first user interface in accordance with embodiments of the present disclosure.

FIG. 13 is a block diagram of a messaging engine of a second user interface in accordance with embodiments of the present disclosure.

FIG. 14 is a block diagram of a notification engine of a second user interface in accordance with embodiments of the present disclosure.

FIG. 15 is a block diagram of a tracking engine of a second user interface in accordance with embodiments of the present disclosure.

FIG. 16 is a block diagram of a computing device configured to implement embodiments of an ornament system in accordance with embodiments of the present disclosure.

FIG. 17 is a block diagram of a distributed environment for implementing embodiments of an ornament system in accordance with embodiments of the present disclosure.

FIG. 18 is a flowchart illustrating implementation of an ornament system in accordance with embodiments of the present disclosure.

FIG. 19 is a flowchart illustrating implementation of an ornament system in accordance with embodiments of the present disclosure.

FIG. 20 is a graphical user interface window of an ornament system in accordance with embodiments of the present disclosure, which shows a link to an application on a user interface.

FIG. 21 is a graphical user interface window of an ornament system in accordance with embodiments of the present disclosure, which shows a log-in interface.

FIG. 22 is a graphical user interface window of a first user interface in accordance with embodiments of the present disclosure, which shows a messaging interface.

FIG. 23 is a graphical user interface window of a first user interface in accordance with embodiments of the present disclosure, which shows a messaging interface.

FIG. 24 is a graphical user interface window of a first user interface in accordance with embodiments of the present disclosure, which shows a messaging interface.

FIG. 25 is a graphical user interface window of a first user interface in accordance with embodiments of the present disclosure, which shows a gift interface.

FIG. 26 is a graphical user interface window of a first user interface in accordance with embodiments of the present disclosure, which shows a messaging interface.

FIG. 27 is a graphical user interface window of a first user interface in accordance with embodiments of the present disclosure, which shows a scheduling interface.

FIG. 28 is a graphical user interface window of a first user interface in accordance with embodiments of the present disclosure, which shows a scheduling interface.

FIG. 29 is a graphical user interface window of a second user interface in accordance with embodiments of the present disclosure, which shows a messaging interface.

FIG. 30 is a graphical user interface window of a second user interface in accordance with embodiments of the present disclosure, which shows a notification interface.

### DETAILED DESCRIPTION

Exemplary embodiments of the present disclosure are directed to interactive ornaments that allow communication and feedback between the ornament and one or more users. In particular, the ornament allows parents to communicate with their children through the ornament, while the children communicate with the ornament and are under the impression that the communication is occurring with Santa Claus. The children therefore believe that the feedback provided from the ornament is representative of communication to them from Santa Claus. The ornament thereby serves both a decorative purpose and an interactive purpose. Although described herein as an ornament that can be hung on a tree, it should be understood that the ornament can also be in the form of a decorative item that can be placed on a shelf or a similar surface without hanging the ornament, e.g., in a free-standing manner.

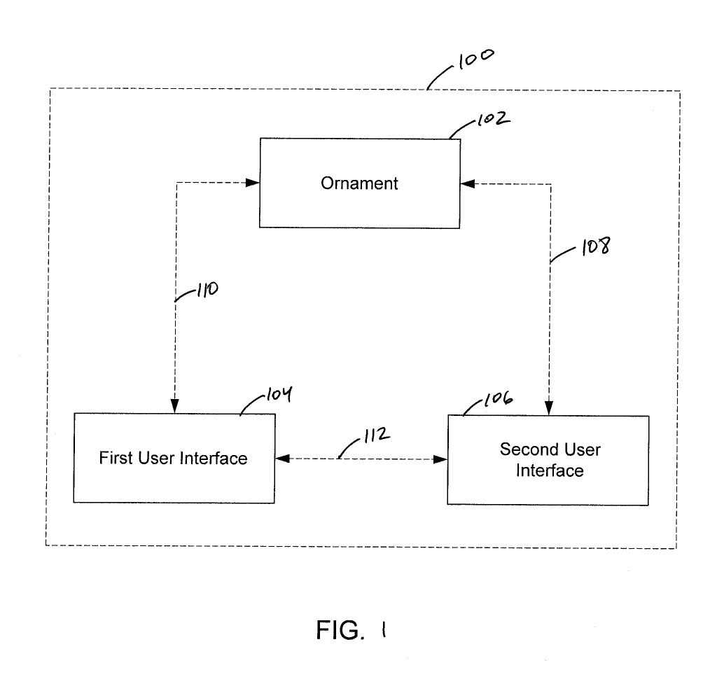

FIG. 1 is a block diagram of an ornament system 100 (hereinafter “system 100”) in accordance with exemplary embodiments of the present disclosure. The system 100 generally includes an ornament 102, a first user interface 104 (e.g., a first graphical user interface (GUI), a parent user interface, or the like), and a second user interface 106 (e.g., a second GUI, a child user interface, or the like). Although illustrated as separate first and second user interfaces 104, 106, in some embodiments, the first and second user interfaces 104, 106 can be located on a single device, e.g., a smart phone, a computer, or the like. For example, the first and second user interfaces 104, 106 can be individually accessed on the device through separate log-in information, e.g., different usernames and passwords, for an application or program on the device. Although illustrated as first and second user interfaces 104, 106, in some embodiments, three or more user interfaces can be used. The ornament 102, first user interface 104, and second user interface 106 can be communicatively linked relative to each other by communication lines 108, 110, 112 in a bi-directional manner through wired and/or wireless means.

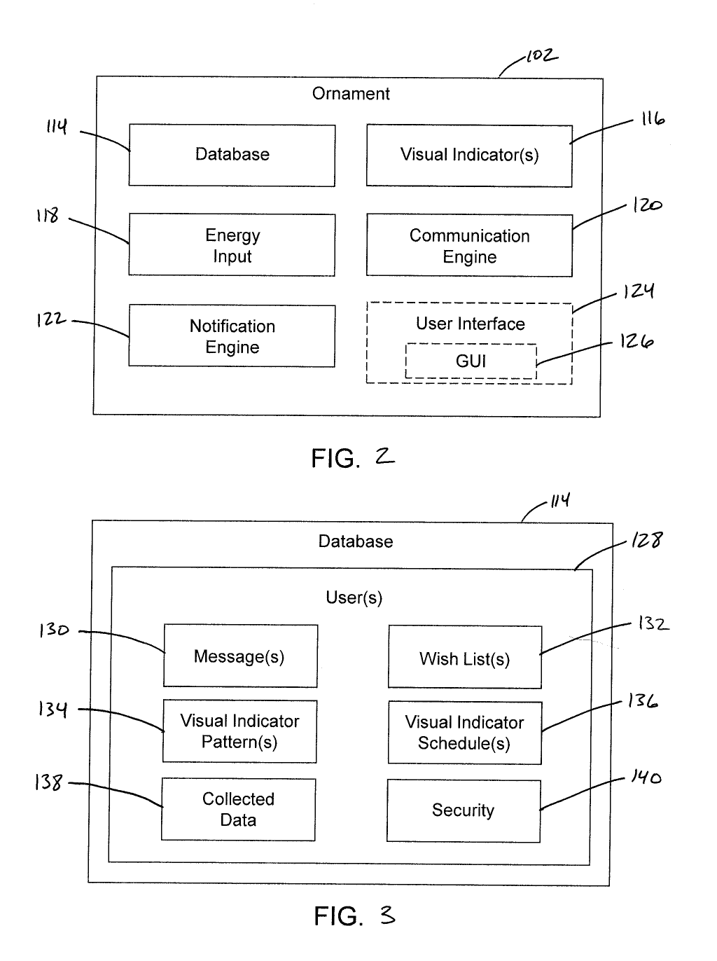

FIG. 2 is a block diagram of the ornament 102 of the system 100 in accordance with exemplary embodiments of the present disclosure. The ornament 102 can include a housing fabricated from glass or plastic. For example, the ornament 102 can be clear, frosted, colored, include one or more designs, combinations thereof, or the like. The ornament 102 can include a database 114 and one or more visual indicators 116. In some embodiments, rather than being in the ornament 102, the database 114 can be stored in the first user interface 104. The ornament 102 can include an energy input 118, a communication engine 120, and a notification engine 122. In some embodiments, the ornament 102 can include a user interface 124 with a graphical user interface 126.

As will be discussed in greater detail below, the database 114 can be configured to store a variety of information related to scheduling and the one or more users communicating with the ornament 102 to provide customized visual notifications to the user(s). The visual indicators 116 can include one or more lights, e.g., light-emitting diodes (LEDs), visible at an outer surface of the ornament 102 and configured to provide visual indications or notifications to the users. It should be understood that the visual indicators 116 can be in a variety of shapes and forms. For example, in some embodiments, the ornament 102 can include a single visual indicator 116. In some embodiments, the ornament 102 can include a plurality of visual indicators 116 visible at the surface of the ornament 102 in a spaced manner. In some embodiments, the visual indicators 116 can be disposed in a small area, e.g., the top portion of the ornament 102, the bottom portion of the ornament 102, or the like. In some embodiments, the ornament 102 can include one or more visual indicators 116 in the form of bands extending across portions of the ornament 102. In some embodiments, the visual indicators 116 can be disposed within the ornament 102 and can be visible through the transparent or translucent housing of the ornament 102. In some embodiments, the visual indicators 116 can at least partially protrude through the housing of the ornament 102 and extend beyond the surface of the housing.

The visual indicators 116 can be wired to a printed circuit board (PCB) disposed within the ornament 102. The PCB can be programmed to vary the colors, patterns, or both, of the visual notifications provided to the user through the visual indicators 116 based on information stored in the database 114 and/or communications with the first and second user interfaces 104, 106. In particular, the visual indicators 116 can be configured to light in a variety of colors and/or patterns. For example, the visual indicators 116 can be actuated to shine, blink or change colors, including red, green, white, or the like, to provide visual indications or notifications to the child as feedback regarding interactions with Santa Claus.

The energy input 118 can include an interface for connecting the ornament 102 to an energy source. In some embodiments, the ornament 102 can include therein a rechargeable battery and the energy input 118 can include an electrical port configured to receive a cable for connecting the ornament 102 to an energy source, e.g., an outlet, for recharging the battery. In some embodiments, the ornament 102 can be configured and dimensioned to receive therein replaceable batteries. In some embodiments, the energy input 118 can be configured to connect directly to a plug associated with a string of lights disposed on the Christmas tree, thereby providing energy to the ornament 102 through the wiring associated with the lights and connected to the energy source.

The communication engine 120 can be programmed into the PCB disposed within the ornament 102 and can be configured to programmatically execute a communication function to receive signals from the first and/or second user interfaces 104, 106 and transmit signals to the first and/or second user interfaces 104, 106. The communication engine 120 can include means for wirelessly receiving and transmitting communication signals, e.g., an antenna.

The notification engine 122 can be programmed into the PCB disposed within the ornament 102 and can be configured to programmatically communicate with the database 114 to determine when notifications should be provided to the one or more users through the visual indicators 116. In particular, the notification engine 122 can execute a notification function based on schedules stores in the visual database and/or signals received from the first and/or second user interfaces 104, 106 and output a visual notification through the visual indicators 116.

In some embodiments, the ornament 102 can include a user interface 124 with a GUI 126. For example, the ornament 102 can include a GUI 126 including input means, e.g., a touch screen, through which a user can input information to be stored in the database 114. In some embodiments, a parent can user the GUI 126 to input information regarding the children interacting with the ornament 102, schedules for providing visual notifications, combinations thereof, date/time information, or the like.

FIG. 3 is a block diagram of the database 114 of the ornament system 100 in accordance with embodiments of the present disclosure. The database 114 can programmatically store information related to one or more users 128. The database 114 can include messages 130 and wish lists 132 associated with the users 128. The database 114 can further include visual indicator patterns 134 and visual indicator schedules 136. In some embodiments, the database 114 can include collected data 138 and security 140.

Messages 130 can store communication between the ornament 102, the first user interfaces 104, and the second user interface 106. In particular, messages 130 can store therein communications (such as text messages) between parents and their children. For example, a parent can use the first user interface 104 to communicate with the child at a second user interface 106. The communications between the first and second user interfaces 104, 106 can be automatically stored in the messages 130 within the database 114. As will be discussed below, the data in the messages 130 can be used to generate advertisements, gift ideas, third party providers of gifts, or the like.

The wish lists 132 can store information related to the gifts a user, e.g., a child, would like for Christmas. The data in wish lists 132 can be pulled directly from the messages 130. For example, when a child sends a message to Santa Claus through the second user interface 106, the text in the message can be stored in the messages 130. The ornament 102 can programmatically pull or query data relating to the one or more gifts the child asks from Santa Claus from messages 130 and into the wish lists 132. Therefore, the wish lists 132 can include a user-specific or child-specific list of the gifts the child would like for Christmas.

The visual indicator patterns 134 can include one or more patterns programmed therein for providing visual notifications through the visual indicators 116. The visual indicator patterns 134 can include different combinations of lights to actuate, as well as different colors of the lights to use during actuation of the visual indicators 116. In some embodiments, some visual indicator patterns 134 can be used to indicate when Santa Claus is near the house on Christmas Eve, e.g., a location/proximity signal. For example, on Christmas Eve, the ornament 102 can illuminate different colors, e.g., red, or green, when Santa Claus is close to or is approaching the house. When the child sees the visual indicators 116 of the ornament 102 lighting up on Christmas Eve, the child will know that Santa Claus is getting closer to the house.

In some embodiments, the visual indicator patterns 134 can provide feedback for communications of a child with Santa Clause. In some embodiments, the visual indicator patterns 134 (and/or visual indicator schedules 136) can be customized for specific users 128. For example, when a child writes a message to Santa Claus and selects to send the message through the second user interface 106, the visual indicators 116 of the ornament 102 can be actuated to turn on, e.g., red or green, indicating to the child that the child's message has been sent to the North Pole and is awaiting Santa Clause's viewing. When the message from the child is opened by Santa Claus, i.e., by the parent through the first user interface 104, the visual indicators 116 of the ornament 102 can flash a different color indicating to the child that the message has been read. When Santa Claus responds to the child by sending a message to the second user interface 106, i.e., when the parent responds to the child, the visual indicators 116 of the ornament 102 can illuminate in a variety of colors, e.g., a firework-like display of illumination, to indicate to the child that a message from Santa Claus has been received at the inbox of the second user interface 104 and is ready to be ready by the child. Based on the visual notification, the child can access the message from Santa Claus through the second user interface 104.

In some embodiments, second user interface 104 can be programmed to maintain a status of each message, e.g., read, unread, or the like, to prevent constant illumination of the ornament. For example, if the message is unread, the ornament 102 can illuminate every few minutes or every hour to indicate to the child that there is an unread message in the inbox. Once the message has been read by the child, the second user interface 104 can communicate with the ornament 102 to update the status of the message in the messages 130, thereby preventing further illumination of the ornament 102 regarding the message. If there are two or more children interacting with the ornament 102, the child can choose a specific color as the color representative of the child through the second user interface 104. Thus, when the ornament 102 illuminates to notify the children of incoming messages, the end of a notification cycle can include an illumination of the ornament 102 in a solid color that corresponds to the color chosen by the child. Each child can thereby understand that which notifications are intended for which child.

The visual indicator schedules 136 can be programmed to include one or more schedules for illuminating the visual indicators 116 in response to communications to and from the ornament 102. As will be discussed in greater detail below, the first user interface 104 can include input areas for allowing the parent to set schedules for activation of the visual indicators 116 or to manually activate the visual indicators 116 through the wireless communication between the first user interface 104 and the ornament 102.

In some embodiments, the database 114 can include collected data 138. In particular, the data in the messages between the first and/or second user interfaces 104, 106 and the ornament 102 can undergo data mining functions to query or pull certain data from the messages and store the data in the collected data 138. For example, the messages can be queried to pull certain words or phrases, such as gift names or company names, and store the pulled data in the collected data 138. In some embodiments, the collected data 138 can be automatically shared with third party retailers of the specific products discussed in the messages to determine the demand or interest for their products. In some embodiments, the collected data 138 can be automatically shared with the third party retailers of the specific products discussed in the messages such that the third party retailers can issue advertisements to the parents through the first user interface 104. In some embodiments, the collected data 138 can be used to provide the parents with an interface where the parent can shop for the products mentioned in the messages, thereby providing an efficient and convenient method of purchasing gifts for the child.

Security 140 can store information related to the user. For example, security 140 can store information relating to the name of the user, the age of the user, the location of the user, the user name of the user, the password or code of the user, a secret question and answer to retrieve the password or code of the user, combinations thereof, or the like. Security 140 can also include information relating to an account created by the user to access the first and/or second user interface 104, 106. The user can thereby use a device, e.g., a smart phone, a computer, or the like, to access the first and/or second user interface 104, 106 by logging into an application on the device. In some embodiments, the security 140 can be stored in each respective user interface, e.g., first and second user interfaces 104, 106.

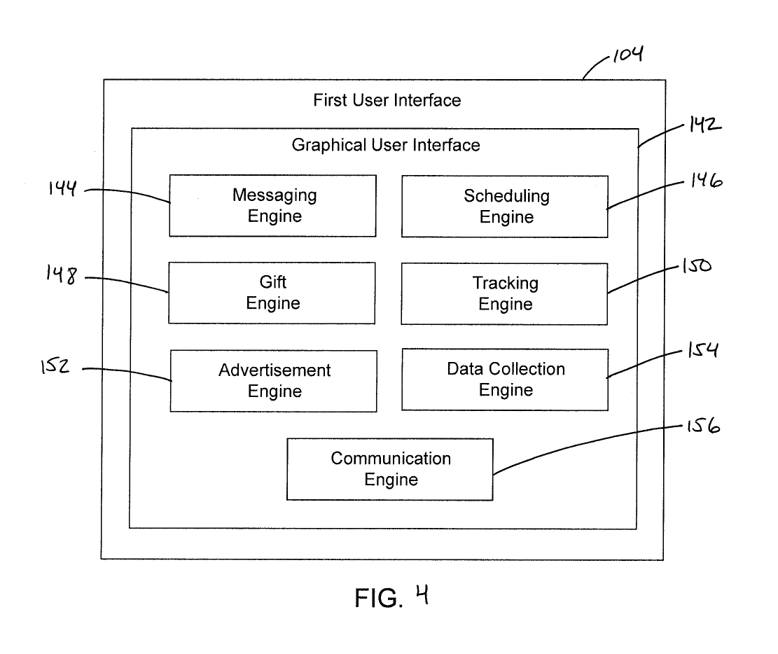

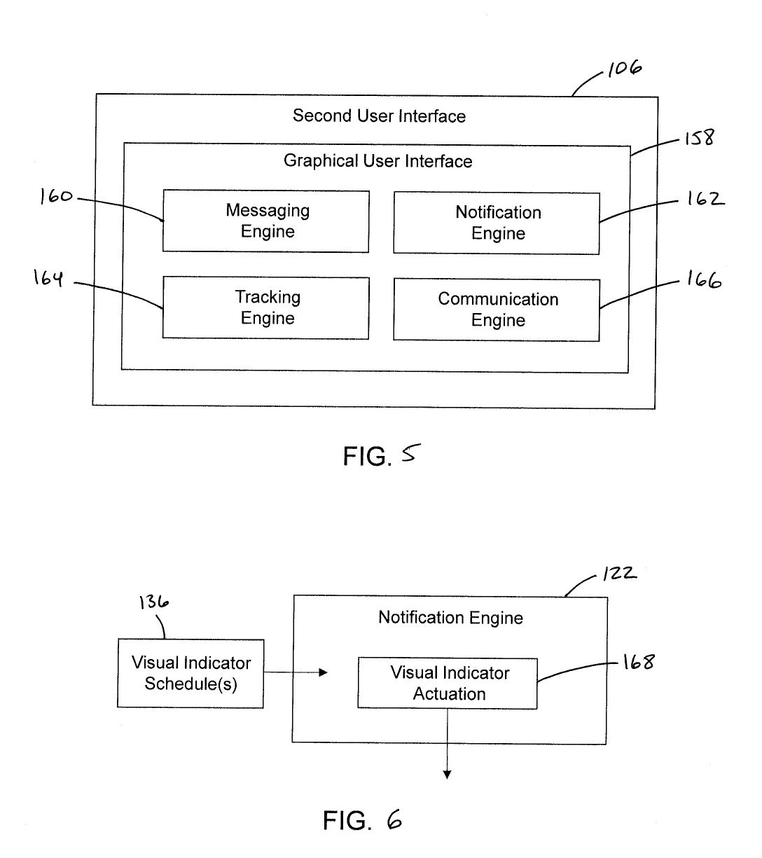

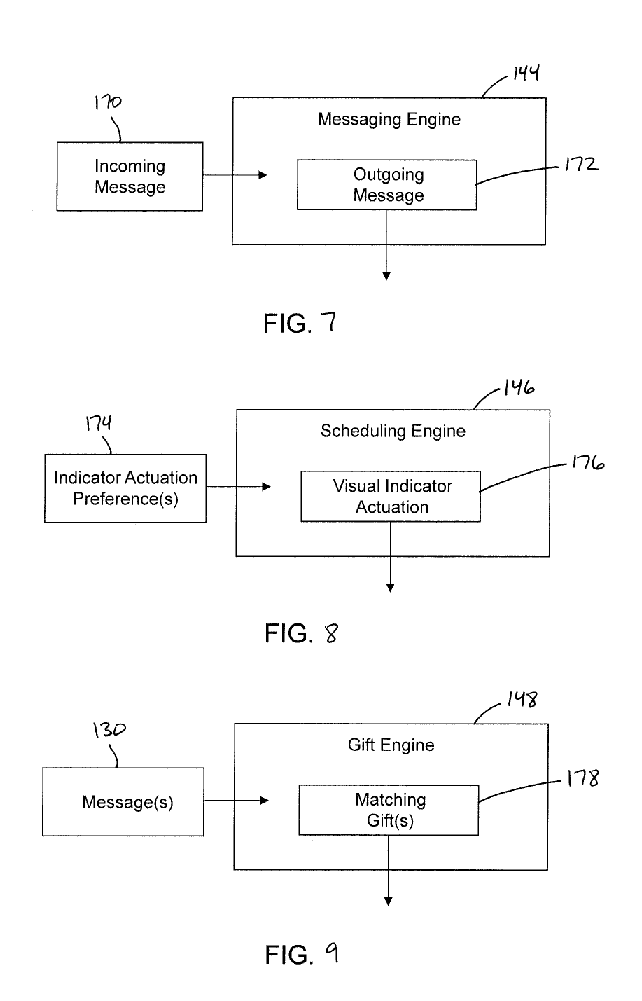

FIG. 4 is a block diagram of the first user interface 104, e.g., a parent's user interface, of the system 100 in accordance with embodiments of the present disclosure. The first user interface 104 can include a graphical user interface (GUI) 142 for interacting and communicating with the ornament 102 and the second user interface 106. The first user interface 104 can include a messaging engine 144, a scheduling engine 146, and a gift engine 148. The first user interface 104 can further include a tracking engine 150 and a communication engine 156. In some embodiments, the first user interface 104 can include an advertisement engine 152 and a data collection engine 154.

The messaging engine 144 can be programmed to execute a messaging function to create, send and receive messages to/from the second user interface 106. In particular, the messaging engine 144 creates a messaging interface between the first and second user interfaces 104, 106 and the ornament 102. The messages sent and/or received by the messaging engine 144 can be stored in the messages 130 of the database 114. The messaging platform can include messages related to each child communicating with the ornament 102 through the second user interface 106. The messaging platform can further include a notification indicator that notifies the parent when a new message has been received in the messaging engine 144. The messaging engine 144 can include a database substantially similar to the database 114, including at least the messages 130 and wish lists 132.

The scheduling engine 146 can be programmed to execute a scheduling function by the parent to create and modify schedules for actuating the visual indicators 116 of the ornament 102. In some embodiments, the scheduling engine 146 can include an interface for manually turning on the visual indicators 116 of the ornament 102. The scheduling engine 146 can include options for the lighting colors to illuminate and/or the lighting patterns. The scheduling engine 146 can include a timer interface through which the parent can set a specific time period in which the visual indicators 116 are illuminated. In some embodiments, the scheduling engine 146 can include a timer interface for scheduling illumination of the visual indicators 116 for a variety of statuses, e.g., message sent to Santa Claus, message received by Santa Claus, message read by Santa Claus, message from Santa Claus received, gift on its way to the house, gift at the house, Santa Claus at the house, Santa Claus is flying over the house, or the like.

The gift engine 148 can use the data from the messages to populate an interface through which the parent can purchase gifts desired by the child. For example, the gift engine 148 can programmatically execute a gift function to use the wish list 132 data from the database 114 to populate a gift list in the GUI 142 for the parent. The gift engine 148 can incorporate advertisements and/or links to third party retailers through which the parent can purchase the gifts requested by the child through the messaging system. In some embodiments, the GUI 142 can include an interface for searching, saving, and purchasing the gifts without exiting the application on the device.

The tracking engine 150 can be used by the parent to track the location or proximity of Santa Claus relative to the house. For example, the tracking engine 150 can include manual activation or a scheduling interface similar to the scheduling engine 146 for activating illumination of the visual indicators 116 to indicate a proximity of Santa Claus on Christmas Eve. The illumination pattern and/or colors corresponding to the proximity of Santa Claus can be unique relative to the illumination pattern and/or colors used for notifications regarding message communications.

In some embodiments, the tracking engine 150 can provide an animated tracking interface for indicating the location of Santa Claus around the world. For example, the tracking engine 150 can show that at the current time, Santa Claus is flying over London, England. The tracking engine 150 can update the location of Santa Claus periodically or in real time to indicate that Santa Claus is approaching the city of the user. For example, the tracking engine 150 can indicate that Santa Claus is approaching the city of the user when the local time approaches Christmas Eve. In some embodiments, the tracking engine 150 can include an interface including an animated globe with an icon representing Santa Claus, such that the location of Santa Claus in the world can be seen.

The advertisement engine 152 can programmatically execute an advertisement function to query data from the wish list 132 and/or the collected data 138 stored in the database 114 and issue one or more advertisements in the GUI 142. In particular, the advertisements can be specifically selected and issued based on the subject matter or the gift names from the wish list 132 and/or the collected data 138, thereby providing the parent with a single interface through which to determine the gifts the child would like for Christmas and access to retailers who sell such gifts. In some embodiments, the advertisement engine 152 can issue advertisements similar or related in subject matter to the gifts in the wish list 132 and/or the collected data 138 to provide the parent with additional gift ideas for the child.

The data collection engine 154 can programmatically execute a data collection function to query or pull data from the messages, such as gift names, and store the data in the wish lists 132 and/or the collected data 138 of the database 114. Gift-specific data can thereby be collected from the plurality of messages between the first and second user interfaces 104, 106, providing the parent with convenient access to a list of gifts desired by the child.

In some embodiments, the first user interface 104 can include a communication engine 156. The communication engine 156 can programmatically assist in sending and receiving messages generated through the messaging engine 144 between the first and second user interfaces 104, 106. The communication engine 156 can also programmatically provide communication between the first user interface 104 and the ornament 102 such that illumination patterns and/or schedules for the visual indicators 116 can be controlled.

FIG. 5 is a block diagram of the second user interface 106, e.g., a child's user interface, of the system 100 in accordance with embodiments of the present disclosure. The second user interface 106 can include a GUI 158 through which the child can interact with the ornament 102 and/or the first user interface 104. The second user interface 106 can include a messaging engine 160, a notification engine 162, a tracking engine 164, and a communication engine 166.

The messaging engine 160 can include a messaging platform through which the child can communicate with Santa Claus, i.e., the parent on the first user interface 104. In particular, the messaging engine 160 allows the child to create, send and receive text messages to the first user interface 104. In some embodiments, the messaging engines 144, 160 of the first and second user interfaces 104, 106 can be used to send photographs and/or voicemail messages and the data collection engine 154 of the first user interface 104 can be programmed to recognize the gifts in the photographs or mentioned in the voicemail message. The child can thereby send messages to Santa Claus regarding the gifts the child would like to receive for Christmas. The data from the messages sent by the child through the messaging engine 160 can be stored in messages 144 in the database 114 and data relating to specific gifts can be queried and stored in wish lists 132 and/or collected data 138 in the database 114. The messaging engine 144 can include a database including the messages 130 between the child and Santa Claus.

The notification engine 162 can receive communications from the first user interface 104 regarding a status of the message, gift and/or Santa Claus. In particular, the notification engine 162 can provide a notification to the child through the second user interface 106 when, e.g., messages have been sent and/or received, a gift has been delivered, Santa Claus is near or at the house, combinations thereof, or the like. For example, the notifications can be push notifications, visual alerts (e.g., one or more blinking lights on the device), audio alerts (e.g., one or more melodies played by the device), combinations thereof, or the like.

The tracking engine 164 can receive communications from the first user interface 104 based on information input by the parent into the tracking engine 150. For example, the tracking engine 164 can receive scheduling information regarding actuation of the visual indicators 116 to notify the child when Santa Claus is near or at the house. Thus, when the visual indicators 116 are scheduled to be illuminated, the tracking engine 164 issue a notification to the child regarding the proximity of Santa Claus. The child can therefore view the ornament 102 and see the illumination of the visual indicators 116 corresponding to the position of Santa Claus relative to the house.

The communication engine 166 can programmatically assist in sending and receiving messages generated through the messaging engine 160 between the first and second user interfaces 104, 106. The communication engine 160 can also programmatically provide communication between the second user interface 106 and the ornament 102 such that the visual indicators 116 can illuminate appropriately based on messages sent by the child through the second user interface 106. For example, when the child sends a message to Santa Claus, the communication engine 160 can programmatically signal the ornament 102 to illuminate the visual indicators 116 with the appropriate pattern and/or color(s) to indicate to the child that the letter has been received.

FIG. 6 is a block diagram of the notification engine 122 of the ornament 102 in accordance with embodiments of the present disclosure. The notification engine 122 can receive as input the visual indicator schedule(s) 136 from the database 114 and can execute a notification function to output a visual indicator actuation 168. In particular, based on the visual indicator schedule 136 set up by the parent through the first user interface 104, the notification engine 122 can actuate the visual indicators 116 of the ornament 102 to provide visual notifications to the child regarding the status of the message, gift, Santa Claus, combinations thereof, or the like. In some embodiments, the notification engine 122 can also output signals to the second user interface 106 to notify the child that the visual indicators 116 of the ornament 102 are being illuminated.

FIG. 7 is a block diagram of the messaging engine 144 of the first user interface 104 in accordance with embodiments of the present disclosure. The messaging engine 144 can receive as input an incoming message 170, e.g., a message composed by and sent by the child through the second user interface 106. The parent can use the messaging engine 144 to execute a messaging function to create and output an outgoing message 172 to the child in the form of a message from Santa Claus. The messaging engine 144 can thereby provide communication between the parent and the child regarding gifts the child would like for Christmas.

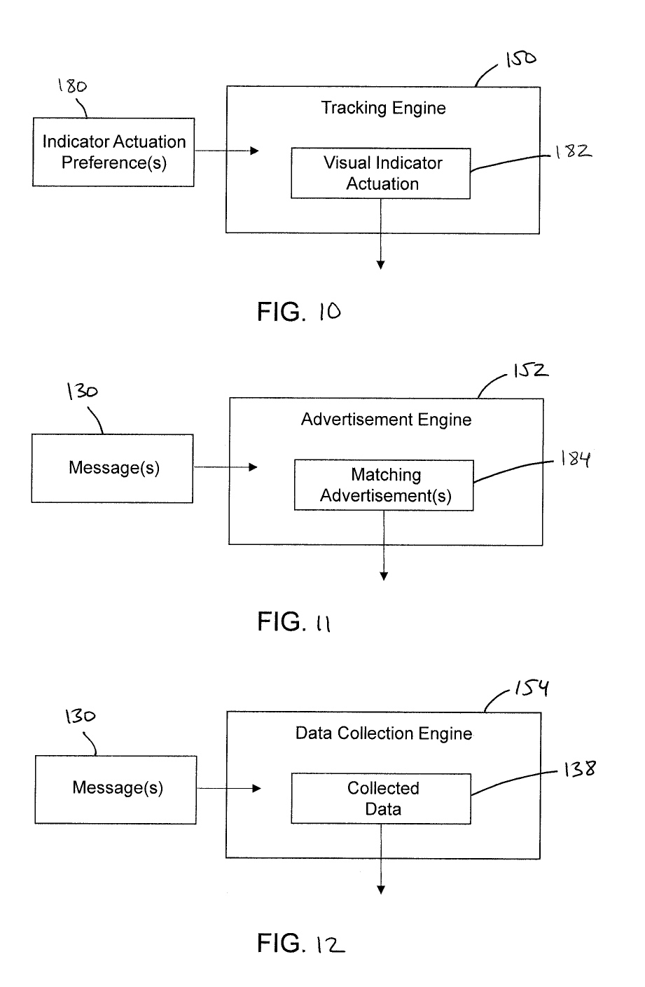

FIG. 8 is a block diagram of the scheduling engine 146 of the first user interface 104 in accordance with embodiments of the present disclosure. The scheduling engine 146 can receive as input one or more indicator actuation preferences 174. The indicator actuation preferences 174 can be input by the parent through the GUI 142 and can indicate, e.g., manual actuation of the visual indicators 116, timer(s) for actuating the visual indicators 116 at different times of the day and/or week, or the like. The scheduling engine 146 can execute a scheduling function based on the input indicator actuation preferences 174 and can output visual indicator actuation 176 at the ornament 102. In particular, based on the preferences selected by the parent at the scheduling engine 146, the scheduling engine 146 can send signals to the ornament 102 to illuminate the visual indicators 116 during the appropriate time periods based on the desired status.

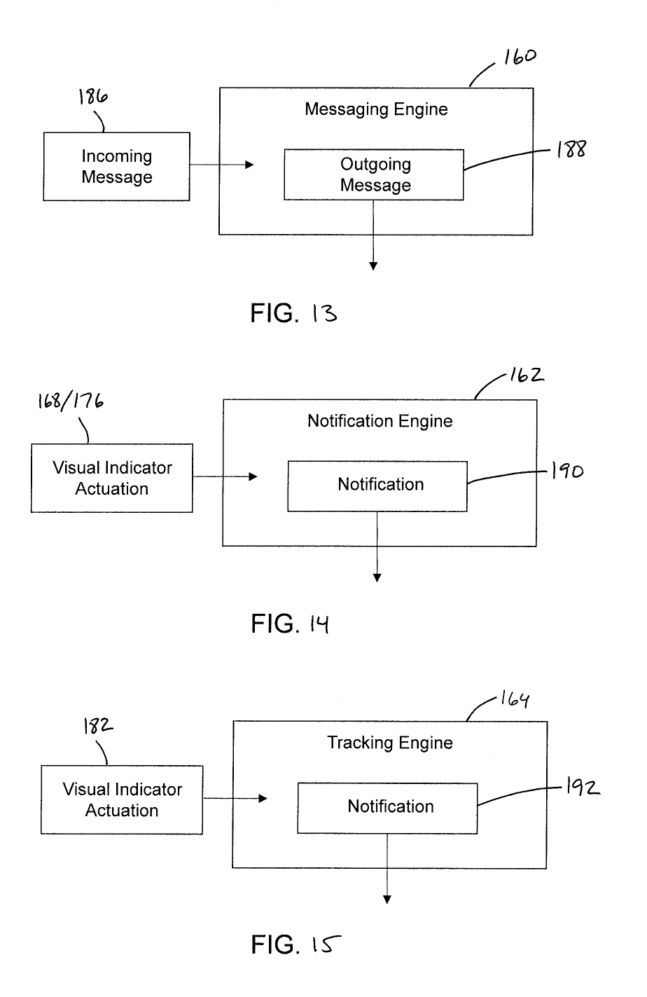

FIG. 9 is a block diagram of the gift engine 148 of the first user interface 104 in accordance with embodiments of the present disclosure. The gift engine 148 can receive as input one or more messages 130 (and/or wish lists 132) stored in the database 114. The gift engine 148 can execute a gift function to query the data within the messages 130 that relates to specific gifts and can output matching gifts 178 to the user through the GUI 142. For example, if the child indicated in a message that the child would like a remote controlled car for Christmas, the gift engine 148 can present the parent with one or more links to third party retailers through which remote controlled cars can be purchased. As a further example, if the child indicated in a message that the child would like a specific brand of a remote controlled car for Christmas, the gift engine 148 can present the parent with a link from which the specific brand of remote controlled cars can be purchased. The gift engine 148 can also be executed to store generated gifts in a saved gifts database for future reference.

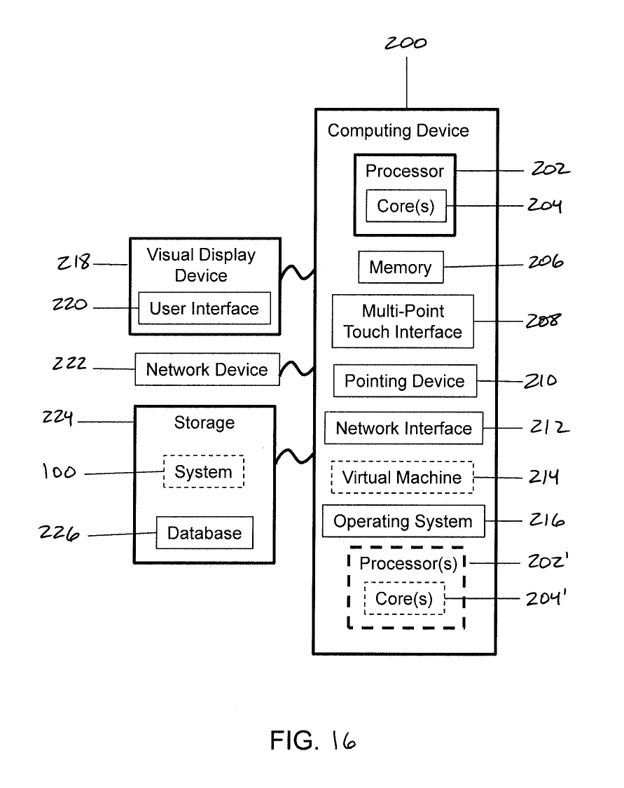

FIG. 10 is a block diagram of the tracking engine 150 of the first user interface 104 in accordance with embodiments of the present disclosure. The tracking engine 150 can receive as input one or more indicator actuation preferences 180. The indicator actuation preferences 180 can be input by the parent through the GUI 142 and can indicate, e.g., manual actuation of the visual indicators 116, timer(s) for actuating the visual indicators 116, or the like, for notifying the proximity or location of Santa Claus relative to the house. The tracking engine 150 can execute a tracking function based on the input indicator actuation preferences 180 and can output visual indicator actuation 182 at the ornament 102. In particular, based on the preferences selected by the parent at the tracking engine 150, the tracking engine 150 can send signals to the ornament 102 to illuminate the visual indicators 116 during the appropriate time periods corresponding to the proximity of Santa Claus to the house.

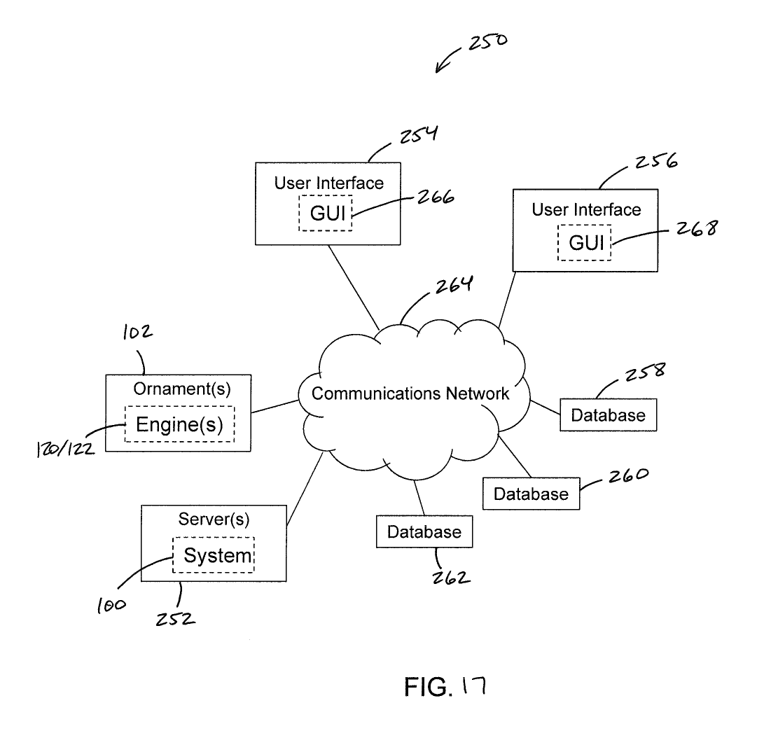

FIG. 11 is a block diagram of the advertisement engine 152 of the first user interface 104 in accordance with embodiments of the present disclosure. The advertisement engine 152 can receive as input one or more of the messages 130 (and/or wish lists 132) from the database 114. The advertisement engine 152 can execute an advertisement function to query data from the messages 130 relating to gifts that the child would like for Christmas. Based on the queried data from the messages 130, the advertisement engine 152 can output matching or related advertisements 184 via the GUI 142. For example, if the child indicated in a message that the child would like a remote controlled car for Christmas, the advertisement engine 152 can output one or more advertisements relating to remote controlled cars. The parent can therefore use the advertisements to review the different products available in the specific category and determine the best deals available through various retailers.

FIG. 12 is a block diagram of the data collection engine 154 of the first user interface 104 in accordance with embodiments of the present disclosure. The data collection engine 154 can receive as input one or more of the messages 130 from the database 114. The data collection engine 154 can execute a data collection function to query data from the messages 130 relating to gifts that the child would like for Christmas. The data collection engine 154 can further output collected data 138 that is stored in the database 114. As noted above, the collected data 138 can be shared with retailers and/or manufacturers to determine interest in the products ahead of the holiday season.

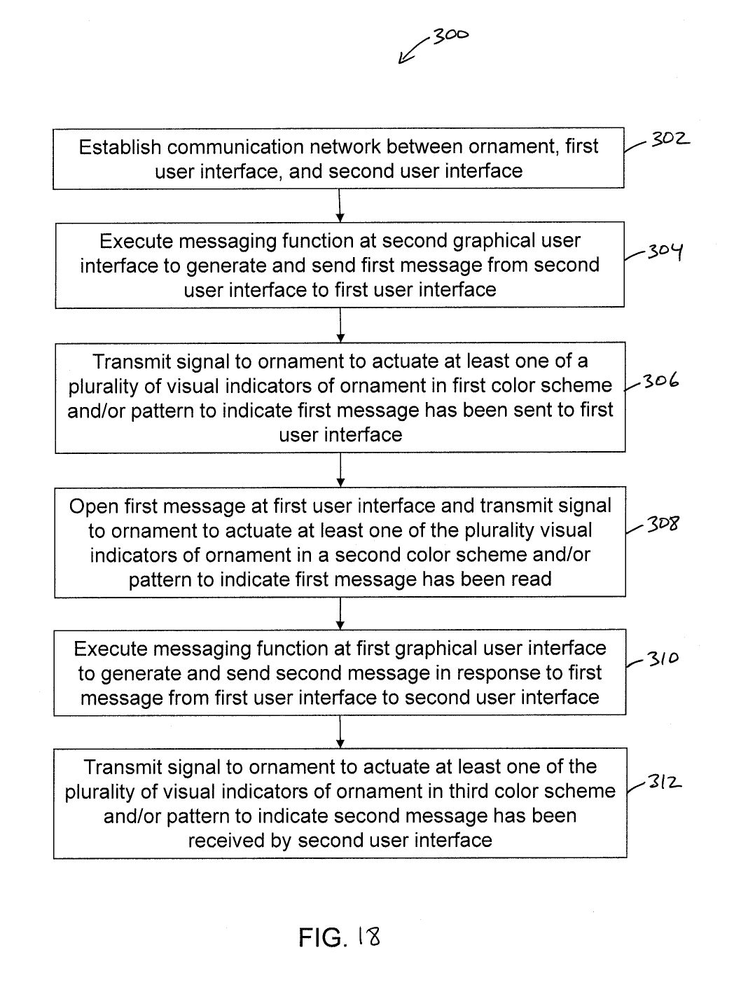

FIG. 13 is a block diagram of the messaging engine 160 of the second user interface 106 in accordance with embodiments of the present disclosure. The messaging engine 160 can receive as input an incoming message 186, i.e., the outgoing message 172 generated and sent by the parent from the first user interface 104, in the form of a message from Santa Claus. The incoming message 186 can be in response to the incoming message 170 initially sent by the child to Santa Claus, i.e., the parent at the first user interface 104, requesting gifts for Christmas. The messaging engine 160 can be used to create and send an outgoing message 188 in response to the incoming message 186. It should be understood that the outgoing message 188 can be sent directly to the messaging engine 144 of the first user interface 104 and a notification can be sent to the parent of the new message in the inbox.

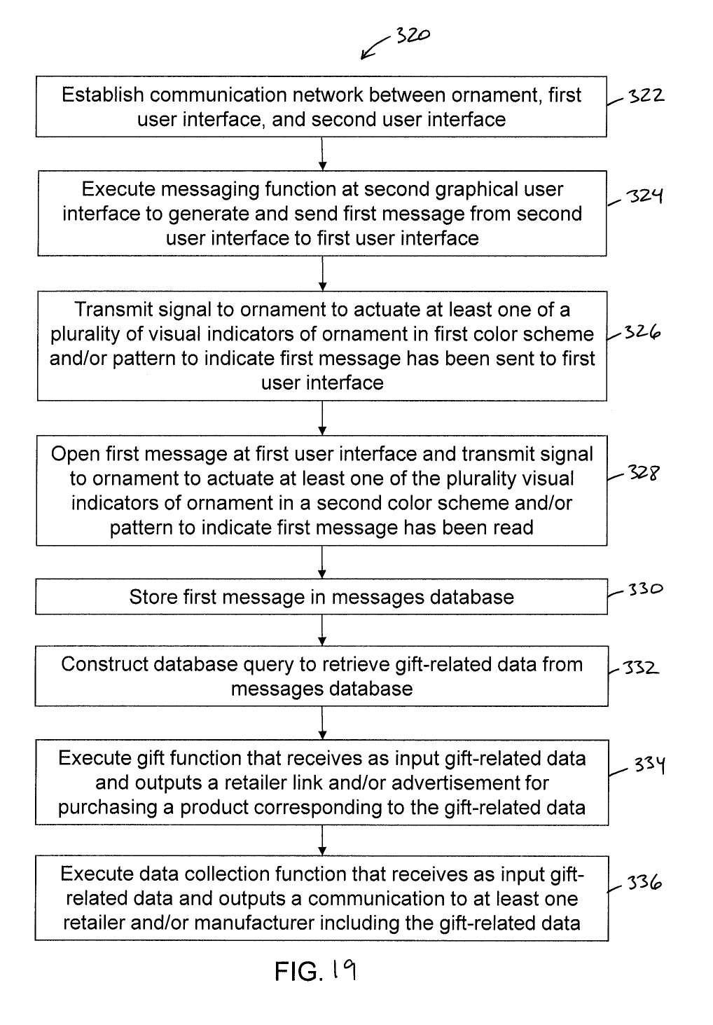

FIG. 14 is a block diagram of the notification engine 162 of the second user interface 106 in accordance with embodiments of the present disclosure. The notification engine 162 can receive as input visual indicator actuation 168, 176 indicating that the visual indicators 116 of the ornament 102 are being illuminated (or will be illuminated in the near future). The notification engine 162 can execute a notification function to output a notification 190, e.g., a push notification, an audio notification, a visual notification, combinations thereof, or the like, to the child via the GUI 158. The notification 190 can indicate to the child that the visual indicators 116 are or will be illuminated in the near future. The child can therefore come to the ornament 102 to see what visual notification the ornament 102 will provide to the child through the visual indicators 116.

FIG. 15 is a block diagram of the tracking engine 164 of the second user interface 106 in accordance with embodiments of the present disclosure. The tracking engine 164 can receive as input visual indicator actuation 182 indicating that the visual indicators 116 of the ornament 102 are being illuminated (or will be illuminated in the near future) based on a proximity of Santa Claus to the house. The tracking engine 164 can execute a tracking function to output a notification 192, e.g., a push notification, an audio notification, a visual notification, combinations thereof, or the like, to the child via the GUI 158. The notification 192 can indicate to the child that the visual indicators 116 are or will be illuminated in the near future due to a proximity of Santa Claus to the house.

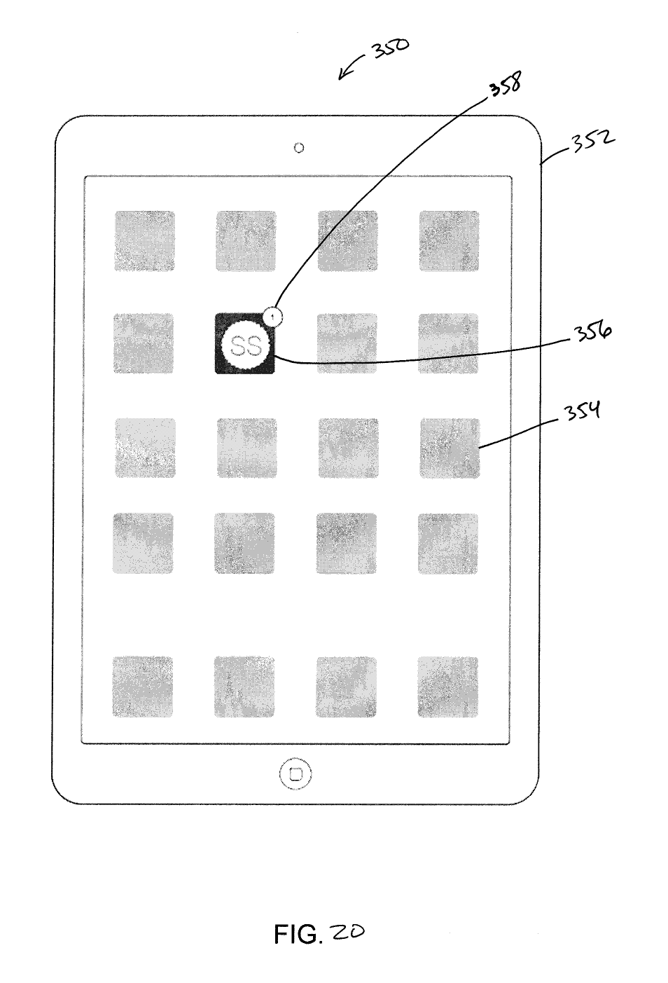

FIG. 16 is a block diagram of a computing device 200 configured to implement embodiments of the system 100 in accordance with embodiments of the present disclosure. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in the computing device 200 may store computer-readable and computer-executable instructions or software for implementing exemplary embodiments of the present disclosure (e.g., the communication engine 120, 156, 166, the notification engine 122, 162, the messaging engine 144, 160, the scheduling engine 146, the gift engine 148, the tracking engine 150, 164, the advertisement engine 152, the data collection engine 154, combinations thereof, or the like). The computing device 200 also includes configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in the computing device 200 so that infrastructure and resources in the computing device may be shared dynamically. A virtual machine 214 may be provided to handle a process running on multiple processors so that the process appears to be using only one computing resource rather than multiple computing resources. Multiple virtual machines may also be used with one processor.

Memory 206 may include a computer system memory or random access memory, such as DRAM, SRAM, EDO RAM, and the like. Memory 206 may include other types of memory as well, or combinations thereof.

A user may interact with the computing device 200 through a visual display device 218, such as a computer monitor or a smart phone screen, which may display one or more user interfaces 220 that may be provided in accordance with exemplary embodiments (e.g., the user interface 124 with the GUI 126, the first user interface 104 with the GUI 142, the second user interface 106 with the GUI 158, or the like). The computing device 200 may include other I/O devices for receiving input from a user, for example, a keyboard or any suitable multi-point touch interface 208 (e.g., a touch screen), a pointing device 210 (e.g., a mouse), or the like. The keyboard 208 and the pointing device 210 may be coupled to the visual display device 218. The computing device 200 may include other suitable conventional I/O peripherals.

The computing device 200 may also include one or more storage devices 224, such as a hard-drive, CD-ROM, or other computer readable media, for storing data and computer-readable instructions and/or software that implement exemplary embodiments of the system 100 described herein. Exemplary storage device 224 may also store one or more databases 226 for storing any suitable information required to implement exemplary embodiments. For example, exemplary storage device 224 can store one or more databases 226 for storing information, such as data stored within the database 114, and computer-readable instructions and/or software that implement exemplary embodiments described herein. The databases 226 may be updated by manually or automatically at any suitable time to add, delete, and/or update one or more items in the databases 226.

The computing device 200 can include a network interface 212 configured to interface via one or more network devices 222 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 212 may include a built-in network adapter, network interface card, PCMCIA network card, card bus network adapter, wireless network adapter, USB network adapter, modem or any other device suitable for interfacing the computing device 200 to any type of network capable of communication and performing the operations described herein. Moreover, the computing device 200 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 200 may run any operating system 216, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 216 may be run in native mode or emulated mode. In an exemplary embodiment, the operating system 216 may be run on one or more cloud machine instances.

FIG. 17 is a block diagram of a distributed environment 250 for implementing embodiments of the system 100 in accordance with embodiments of the present disclosure. The environment 250 can include one or more servers 252 operatively coupled to one or more user interfaces 254, 256, and databases 258-262, via a communication network 264, which can be any network over which information can be transmitted between devices communicatively coupled to the network. For example, the communication network 264 can be the Internet, Intranet, virtual private network (VPN), wide area network (WAN), local area network (LAN), and the like. The environment 250 can include repositories or database devices 259-262, which can be operatively coupled to the server(s) 252, as well as to user interfaces 254, 256, via the communications network 264. In exemplary embodiments, the server(s) 252, user interfaces 254, 256, and database devices 258-262 can be implemented as computing devices (e.g., computing device 200). Those skilled in the art will recognize that the database devices 258-262 can be incorporated into one or more of the servers 252 such that one or more of the servers 252 can include the databases 258-262.

In some embodiments, the database 258 can store information relating to the messages 130, wish lists 132, visual indicator patterns 134, visual indicator schedules 136, collected data 138, and security 140. In some embodiments, database 258 can store information relating to messages and wish lists 132, database 260 can store information relating to visual indicator patterns 134 and visual indicator schedules 136, and database 262 can store information relating to collected data 138 and security 140. In some embodiments, information relating to the messages 130, wish lists 132, visual indicator patterns 134, visual indicator schedules 136, collected data 138, and security 140 can be distributed over one or more of the databases 258-262.

In some embodiments, embodiments of the server 252 can be configured to implement the system 100. In some embodiments, parts of the first user interface 104 and the second user interface 106 can be implemented in a distributed configuration over the server(s) 252. For example, the server 252 can implement the engines 144-156 and 160-166. In some embodiments, one server can implement the engines 144-156 and a second server can implement engines 160-166. In some embodiments, portions of the ornament 102, e.g., engines 120, 122, can be implemented on a separate server. In some embodiments, the user interfaces 254, 256 (e.g., user interface 124, first user interface 104, second user interface 106, or the like) include a graphical user interface 266, 268 for presenting information to the user.

FIG. 18 is a flowchart illustrating an exemplary process 300 of interacting with the ornament 102 in the system 100 in accordance with embodiments of the present disclosure. To begin, at step 302, a communication network between the ornament, the first user interface, and the second user interface can be established. At step 304, a messaging function can be executed by a messaging engine at the second graphical user interface of the second user interface to generate and send a first message from the second user interface to the first user interface. At step 306, a signal can be transmitted to the ornament to actuate at least one of a plurality of visual indicators of the ornament in a first color scheme and/or pattern to indicate that the first message has been sent to the first user interface.

At step 308, the first message can be opened at the first user interface and a signal can be transmitted to the ornament to actuate at least one of the plurality of visual indicators of the ornament in a second color scheme and/or pattern to indicate that the first message has been read. At step 310, a messaging function can be executed by a messaging engine at the first graphical user interface of the first user interface to generate and send a second message in response to the first message from the first user interface to the second user interface. At step 312, a signal can be transmitted to the ornament to actuate at least one of the plurality of visual indicators of the ornament in a third color scheme and/or pattern to indicate that the second message has been received by the second user interface.

FIG. 19 is a flowchart illustrating an exemplary process 320 of interacting with the ornament 102 in the system 100 in accordance with embodiments of the present disclosure. To begin, at step 322, a communication network between the ornament, the first user interface, and the second user interface can be established. At step 324, a messaging function can be executed by a messaging engine at the second graphical user interface of the second user interface to generate and send a first message from the second user interface to the first user interface. At step 326, a signal can be transmitted to the ornament to actuate at least one of a plurality of visual indicators of the ornament in a first color scheme and/or pattern to indicate that the first message has been sent to the first user interface. At step 328, the first message can be opened at the first user interface and a signal can be transmitted to the ornament to actuate at least one of the plurality of visual indicators of the ornament in a second color scheme and/or pattern to indicate that the first message has been read.

At step 330, the first message (and/or additional messages between the first and second user interfaces) can be stored in a messages database. At step 332, a database query can be constructed to retrieve gift-related data from the messages database. In particular, the database query can pull data relevant to, e.g., gift names, brand names, combinations thereof, or the like, from the messages between the first and second user interfaces to determine which gifts the child is requesting for Christmas. At step 334, a gift function can be executed by a gift engine that receives as input the gift-related data and that outputs a retailer link (e.g., a hyperlink) and/or an advertisement for purchasing a product corresponding to the gift-related data. A platform can thereby be provided to the parents at the first user interface through which browsing and purchasing of products corresponding to the requested gifts by the child can be performed, allowing for efficient and convenient shopping. In some embodiments, if the gift engine cannot locate products corresponding to the gift-related data, the gift engine can output retailer links and/or advertisements for products in a substantially similar category of the requested product. At step 336, a data collection function can be executed by a data collection engine that receives as input the gift-related data and that outputs at least one communication to at least one retailer and/or manufacturer associated with the products corresponding to the gift-related data, the communication including the gift-related data. Retailers and/or manufacturers can thereby determine the demand or interest in their products during the holiday season.

FIG. 20 is an exemplary graphical user interface window 350 of the system 100 in accordance with embodiments of the present disclosure. The window 350 is provided to the user on a screen of an electronic device 352, e.g., a computer, a tablet, a smart phone, or the like. The window 350 can include a plurality of icons 354 linking the user to respective applications of the device 352. One of the plurality of icons 354 can be an icon 356 for accessing and running the first user interface 104 and/or the second user interface 106 of the system 100 on the device 352.

It should be understood that the application associated with the first and second user interfaces 104, 106 can be downloadable from the Internet and/or can be included on a storage medium when purchasing the ornament 102. In some embodiments, the ornament 102 can be purchased with a storybook (in electric and/or printed format) explaining the functionality of the ornament 102. For example, the storybook can explain that the ornament 102 has special powers that allow Santa Claus to look into the behavior of the child in order to make sure that the child is being good and deserves to receive presents and/or what the child asked for as a gift for Christmas. The storybook can further explain which lighting schemes and/or patterns of the visual indicators 116 of the ornament 102 correspond with actions taking place both on Christmas Eve and the weeks leading up to Christmas Eve.

Tapping or clicking on the icon 356 can execute a command to open the log-in screen for the first user interface 104 and/or the second user interface 106. The icon 356 can include notifications 358 that appear at the corner of the icon 356 to indicate to the user of activity associated with the system 100, e.g., a status of a gift, a status of a message, or the like. For example, the notification 358 can be in the form of a number within a circle, the number corresponding to the number of items of activity associated with the system 100.

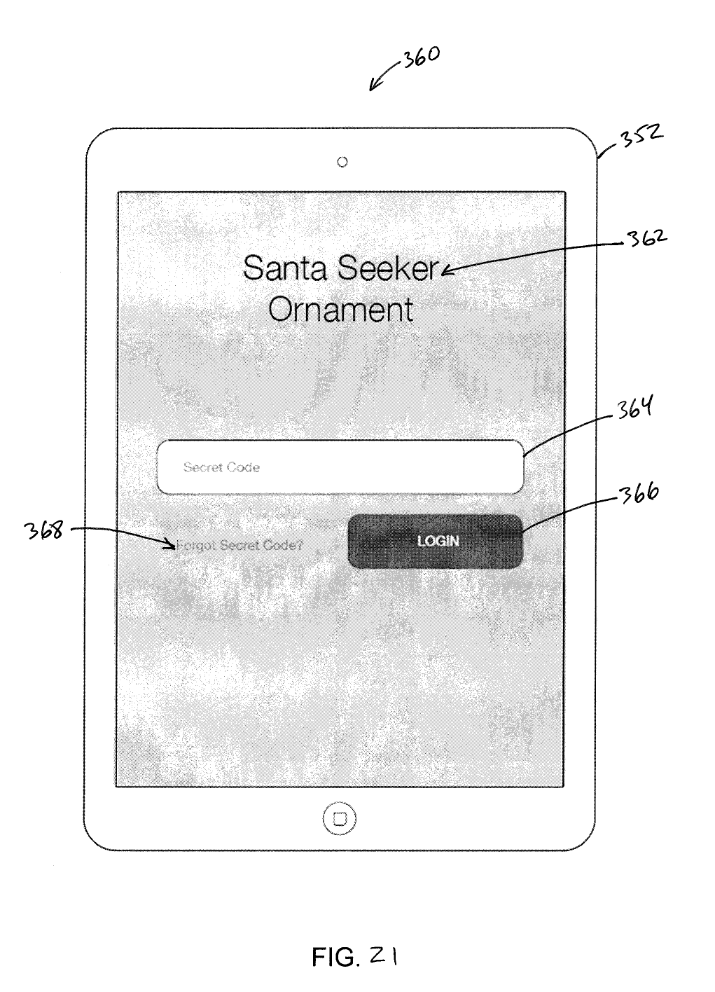

FIG. 21 is an exemplary graphical user interface window 360 of the system 100 in accordance with embodiments of the present disclosure. In particular, the window 360 includes a log-in interface for accessing the first user interface 104 and/or the second user interface 106 of the system 100. The parent and the child can use unique usernames and/or passwords or passcodes to log in to the respective first and second user interfaces 104, 106. Using the different passcodes to log in, the parent and child can have different access levels of the application. The window 360 can include a title section 362 that includes the title of the application or the system 100. For example, the title in FIG. 21 is shown as “Santa Seeker Ornament”. The window 360 can include a data entry section 364 in which the unique passcode of the user can be entered. The data entry section 364 can receive as input an alphanumeric passcode.

The window 360 can include a log-in button 366 that can be actuated (e.g., pressed) to enter the unique passcode and access the first and/or second user interface 104, 106. The window 360 can include a hyperlink 368 for resetting or retrieving a forgotten passcode. For example, the user account can be linked to an e-mail address of the user and the hyperlink 368 can be used to send the forgotten passcode to the e-mail address or secret questions can be answered to retrieve the forgotten passcode.

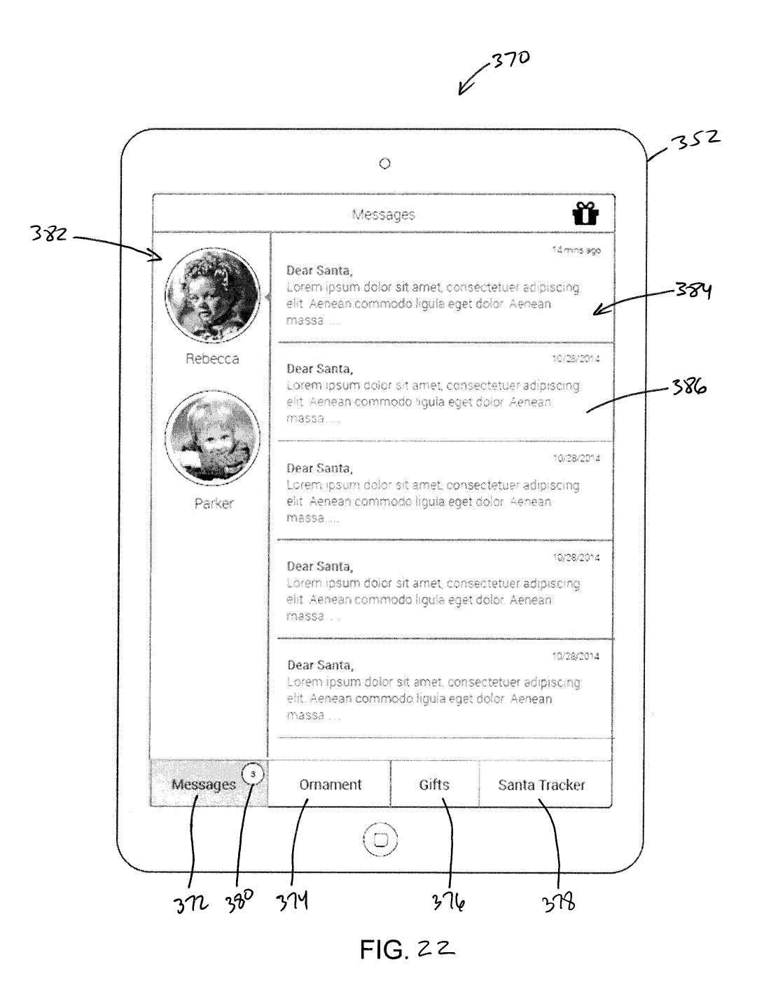

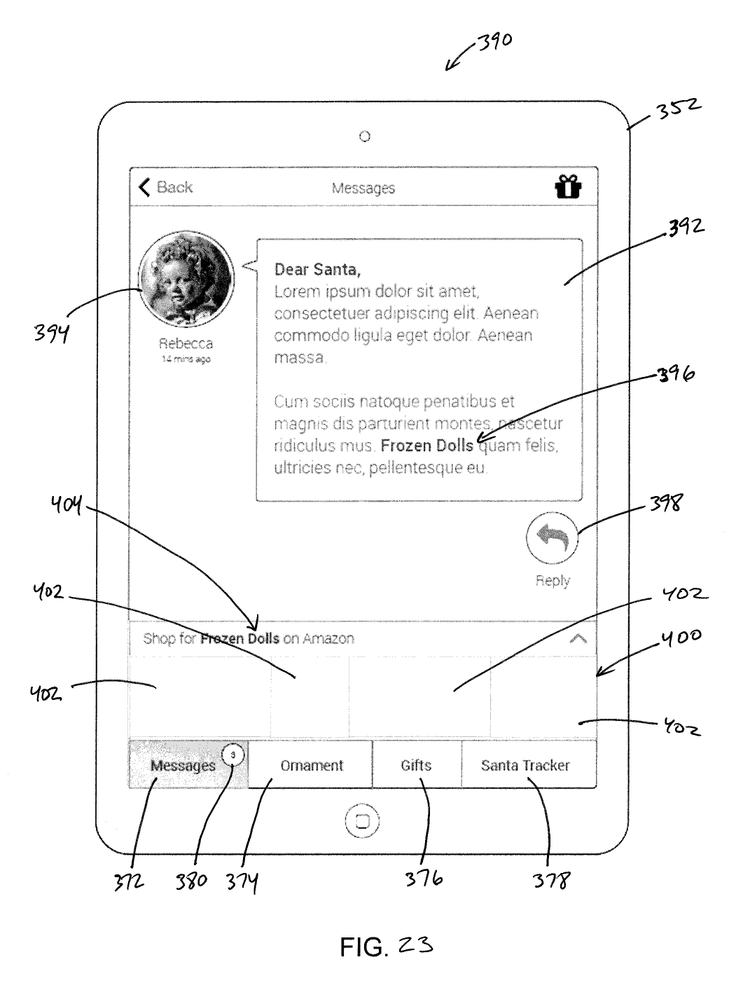

FIG. 22 is an exemplary graphical user interface window 370 of the system 100 in accordance with embodiments of the present disclosure. In particular, the window 370 can include a messaging interface for the first user interface 104 for a parent. The messaging interface provides a system for sorting and organizing messages between the first and second user interfaces 104, 106. The window 370 can include a plurality of tabs at the bottom of the window 370 for accessing various interfaces of the first user interface 104. For example, the first tab 372 can correspond to a messaging interface, the second tab 374 can correspond to a scheduling interface, the third tab 376 can correspond to a gift interface, and the fourth tab 378 can correspond to a tracking interface. A notification 380 can appear on one or more of the tabs 372-378 based on the interface in which an activity has taken place. For example, the notification 380 of FIG. 22 indicates three new message activities in the messaging interface. Selecting the respective tabs 372-378 permits the user to move between interfaces depending on the action to be taken by the user.

The window 370 can include a first section 382 and a second section 384. The first section 382 can include a list of one or more users of the second user interface 106, e.g., children, who are interacting with the parent through the system 100. For example, the first section 382 includes a list of two children, i.e., Rebecca and Parker. In some embodiments, the first section 382 can include a list including photographs of the respective users. Selecting a specific user can show a list of messages 386 associated with the specific user in the second section 384. The messages 386 were generated and sent to the first user interface 104 through the messaging engine 160 of the second user interface 106. Each time the message 386 are sent by the child from the second user interface 106, a signal can be sent to activate at least one of the visual indicators 116 of the ornament 102 to provide visual feedback to the child that the message 386 has been sent. The second section can include a list of messages 386 and at least a partial preview of the content of each message 386. Each message 386 can include a date and/or time step associated with the message 386 and shown in the preview in the second section 384. Each message 386 can be individually selected for full viewing by clicking or taping on the message 386 of interest. The content of the messages 386 can be stored in the messages 130 of the database 114.

FIG. 23 is an exemplary graphical user interface window 390 of the system 100 in accordance with embodiments of the present disclosure. The window 390 can include a messaging interface showing a specific message 392 (e.g., a first message) in the first user interface 104 for a parent. In particular, when a user selects a specific message 386 from the window 370 of FIG. 22, the first user interface 104 can retrieve the entire content of the message 392 to read the message. Upon selecting the specific message 386 and opening the entire content of the message 392, a signal can be sent to the second user interface 106 to notify that a change in status or an activity has occurred, i.e., that the message 392 has been read, and a second signal can be sent to activate at least one of the visual indicators 116 of the ornament 102 to provide visual feedback to the child that the message 392 has been read. The window 390 can include a first section 394 indicating the user or child from whom the message 392 was sent. The message 392 can include the content relating to the text written by the user or child. The text can include correspondence from the child to Santa Claus requesting one or more gifts. For example, the text of the message 392 can include the name or title 396 of a gift of interest, e.g., Frozen Dolls.

The window 390 can include a reply button 398 for responding to the message 392 from the child, e.g., generating and sending a message to the child with the messaging engine 144. The window 390 can include an advertisement or shopping section 400 that includes one or more links 402 to retailers and/or manufacturers (e.g., online retail stores) from whom it is possible to purchase the gift mentioned in the message 392. In particular, as noted above, the gift engine 148, the advertisement engine 152 and/or the data collection engine 154 of the first user interface 104 can be used to scan or query data from the message 392 and determine the retailers and/or manufacturers that sell the product mentioned in the message 392 (and/or to provide recommendations for the parent for gifts to assist the parent in shopping for gifts). The links 402 thereby provide substantially immediate access for the parent to information relating to purchasing of the gift.

In some embodiments, the links 402 can include a graphical representation of the product and the cost associated with the product, thereby allowing the parent to browse and choose the lowest cost for the product. In some embodiments, the parent can purchase the gift directly through the first user interface 104. In some embodiments, selecting a link 404 can lead the user to a third party graphical user interface, e.g., AMAZON®, TOYS-R-US®, or the like, via the Internet through which the product can be purchased. For example, the section 400 can show a partial list of the links 402 and selecting the link 404 can provide the parent with a complete list of links 402 through which the parent can browse.

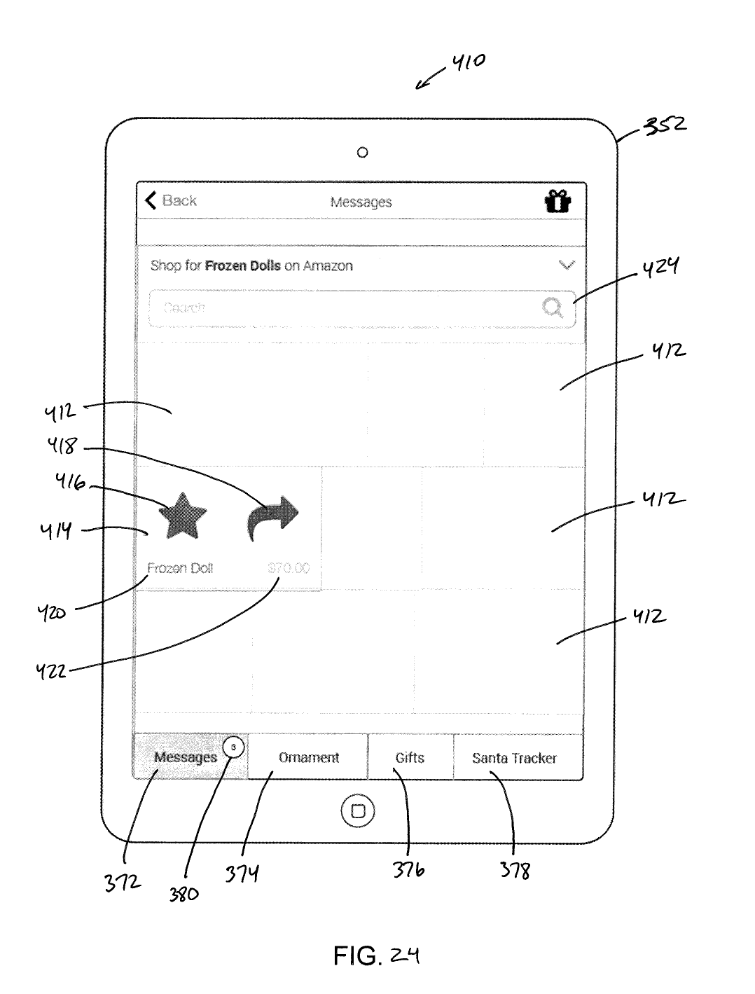

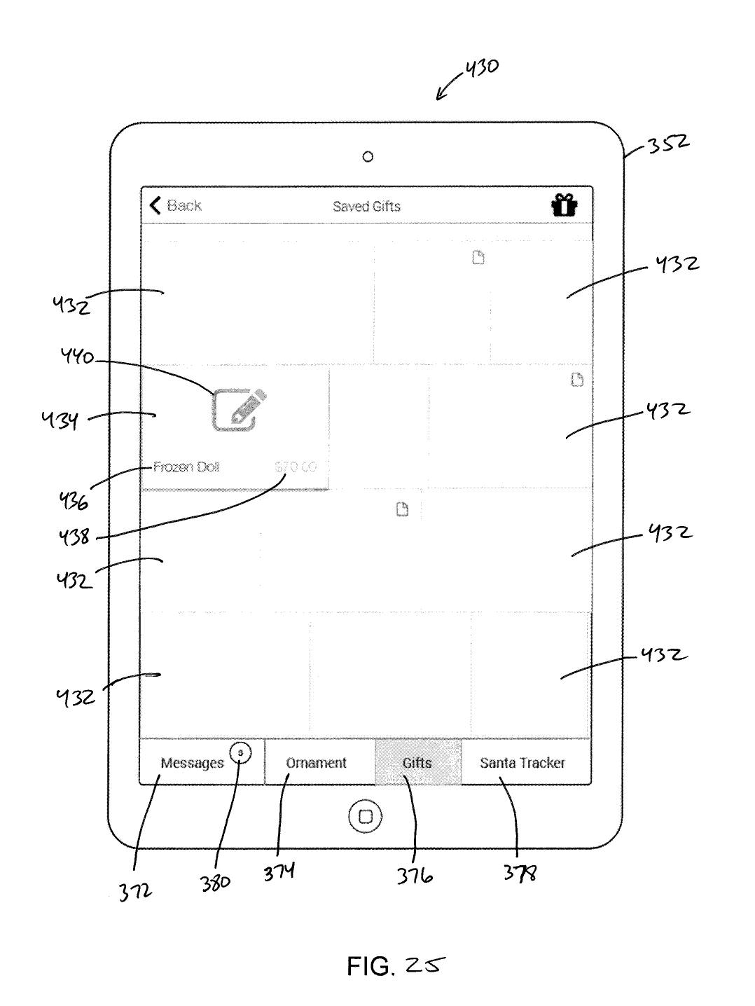

FIG. 24 is an exemplary graphical user interface window 410 of the system 100 in accordance with embodiments of the present disclosure. The window 410 can include a messaging interface of the first user interface 104 through which the parent can browse and purchase gifts associated with the text of the message 392. The window 410 can be accessed by selecting the link 404 at the window 390 of FIG. 23. Selecting the link 404 can expand the section 400 into the window 410 to provide more convenient browsing of the products. The window 410 can include a plurality of links 412 to retailers and/or manufacturers from whom it is possible to purchase the gift mentioned in the message 392, e.g., products associated with the title 396 of the gift.

For example, link 414 provides a link to the gift Frozen Dolls mentioned in the message 392 of FIG. 23. The link 414 can include a first selection 416, e.g., a star, that can be selected to add the gift to a favorite gift list. The link 414 can further include a second selection 418, e.g., an arrow, that can be selected to exit the first user interface 104 and access a retailer graphical user interface for purchasing the product. Each link 412 can include the product name 420 and the price 422 associated with the product. In some embodiments, the window 410 can include a data entry section 424, e.g., a search window, in which the user can enter search terms or keywords for narrowing the results of the links 412 shown in the window 410.

FIG. 25 is an exemplary graphical user interface window 430 of the system 100 in accordance with embodiments of the present disclosure. The window 430 can show the gift interface that can be accessed by selecting the third tab 376. The window 430 can provide a list or grouping of links 432 that the user has saved as favorite gifts by selecting the first selection 416 in the window 410. In particular, the window 430 can include links 432 that the user has selected for future viewing based on an interest in purchasing the product. Each link 432 can include information relating to products offered for sale by retailers and/or manufacturers and selection of the link 432 can lead to a third party graphical user interface through which the product can be purchased. For example, link 434 relates to the Frozen Dolls product and includes the product name 436 and the cost 438 of the product. In some embodiments, the link 434 can include a selection 440 for opening an electronic notepad to add notes regarding the product in the link 434, e.g., thoughts the user may have at the time of viewing the product, or the like. In some embodiments, the selection 440 can be used to input notes, indicate a favorite product, save the product, combinations thereof, or the like, such that the user can refer to the input made in the selection 440 at a future date.

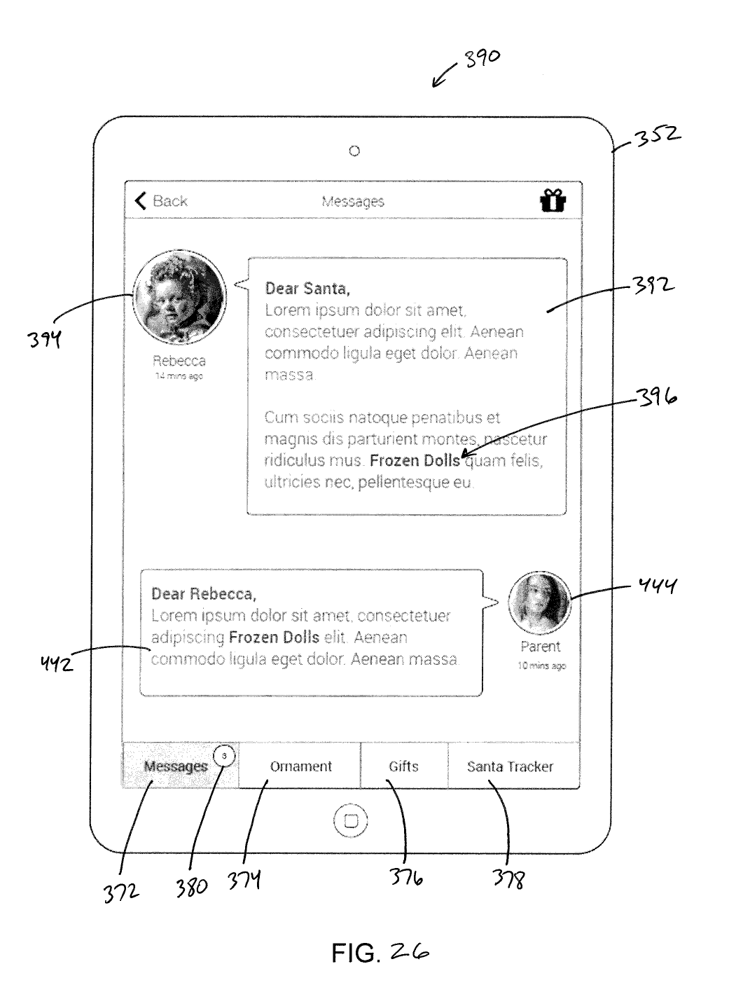

FIG. 26 is an exemplary graphical user interface window 390 of the system 100 in accordance with embodiments of the present disclosure. In particular, FIG. 26 shows the window 390 of FIG. 23 with a response provided by the parent through the messaging engine 144 of the first user interface 104. The parent can access an input means, e.g., a keypad or keyboard, by selecting the reply button in the window 390. The parent can use the input means to generate and send a reply message 442 (e.g., a second message) to the child. The reply message 442 can be in the form of a message from Santa Claus. The window 390 can include an indicator 444, e.g., an icon or photograph, showing the parent or user that sent the reply message 442 to the child. Upon sending the reply message 442, a signal can be sent to the second user interface 106 to notify the child of the reply message 442 in the inbox of the second user interface 106, and a second signal can be sent to activate at least one of the visual indicators 116 of the ornament 102 to provide visual feedback that a reply message 442 has been sent by Santa Claus to the child.

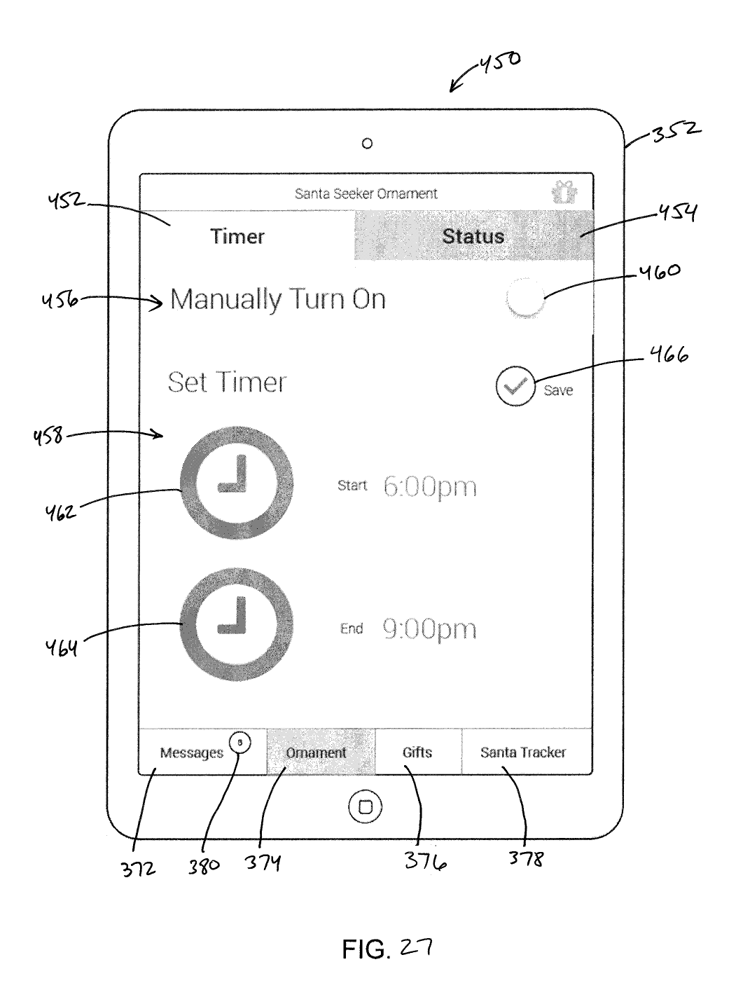

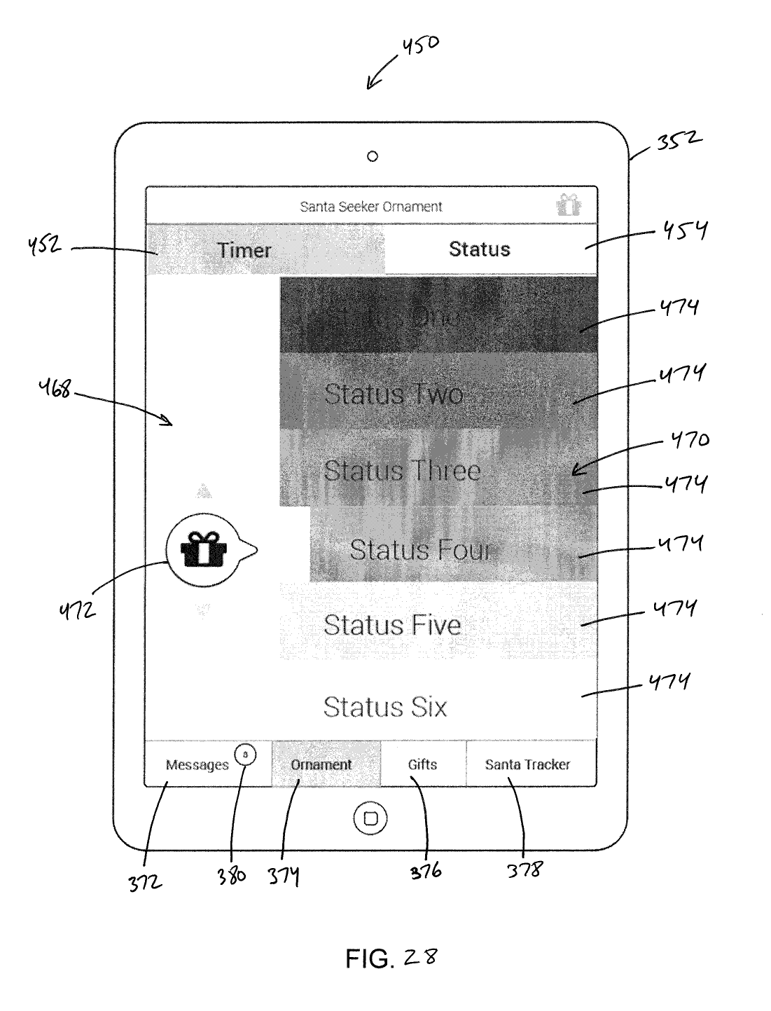

FIG. 27 is an exemplary graphical user interface window 450 of the system in accordance with embodiments of the present disclosure. The window 450 can be accessed by selecting the second tab 374 and can show an exemplary scheduling interface. The scheduling interface can be used to manually actuate the visual indicators 116 of the ornament 102, set a timer schedule for actuating the visual indicators 116 of the ornament 102, set a status of the gift, combinations thereof, or the like. The window 450 can include a timer tab 452 and a status tab 454. Each tab 452, 454 can be selected by the user to switch between two sub-interfaces.

The timer tab 452 can a manual actuation section 456 and a timer actuation section 458. The manual actuation section 456 can include an actuator 460 that can be translated between an “ON” position and an “OFF” position. FIG. 27 shows the actuator 460 in an “OFF” position. However, it should be understood that translating the actuator 460 in a rightward direction would position the actuator 460 in an “ON” position indicated by a green background behind the actuator 460. Actuating the actuator 460 into the “ON” position allows the parent to manually actuate or illuminate the visual indicators 116 of the ornament 102. In some embodiments, the parent can select a specific color scheme, pattern and/or color shades for manual actuation.

The timer actuation section 458 can include a start timer 462 and an end timer 464 that can be used to specify a start time and an end time, respectively, for actuating the visual indicators 116 of the ornament 102. In some embodiments, multiple timer schedules can be saved in the window 450 such that the visual indicators 116 can be actuated at different times of the day. In some embodiments, the time actuation section 458 can include a calendar such that timers can be saved for different days. The parent can thereby specify the time periods in which the visual indicators 116 of the ornament 102 should be illuminated in advance. The save button 466 can be actuate to save the data input for a timer.

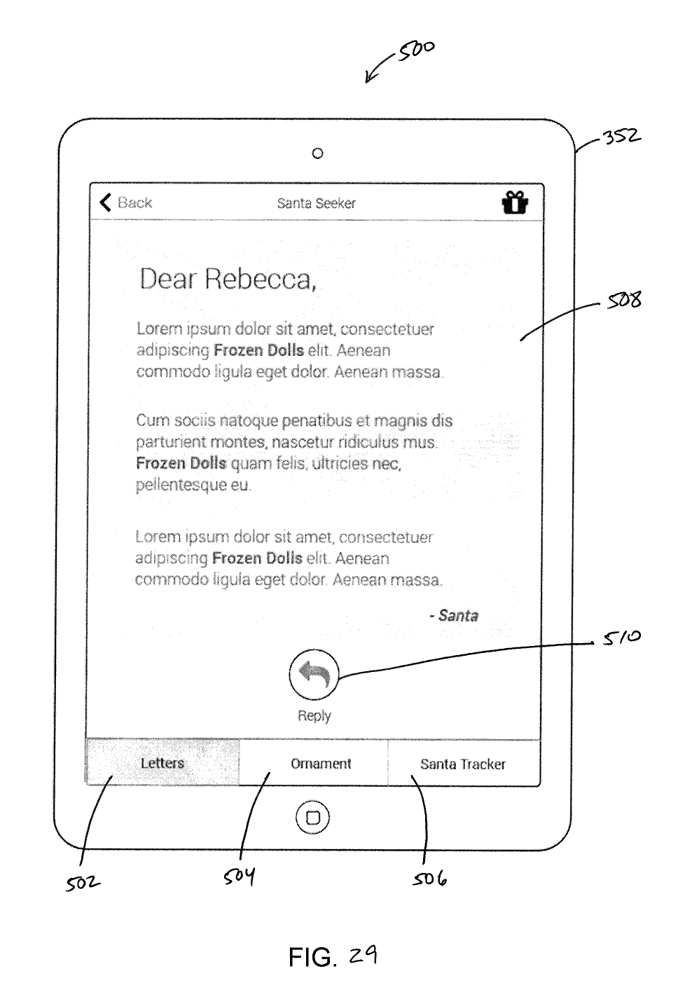

FIG. 28 is an exemplary graphical user interface window 450 of the system 100 showing the status tab 454 selected. The window 450 can include a first section 468 and a second section 470. The first section 468 can include an icon 472 vertically translatable between different positions corresponding to individual statuses 474 of the second section 470. In some embodiments, the individual statuses 474 can be numbered, e.g., status one to status six. The icon 472 can be vertically translated and can snap into a position adjacent to and corresponding to a specific status. Each status can indicate the status of a requested gift by a child and/or a proximity of Santa Claus to the house.

For example, status one can indicate that the child has sent a message to Santa Claus (i.e., the parent at the first user interface 104) through the second user interface 106 indicating the desired gift. Status two can indicate the message has been read by the parent at the first user interface 104. Status three can indicate that a reply message has been sent by the parent to the second user interface 106. Status four can indicate that that the gift is on its way to the child, e.g., that Santa Claus is delivering presents and getting closer to the house. Status five can indicate that Santa Claus is approaching the house. Status six can indicate that Santa Claus has brought the gift for the child.

Selection of a specific status can send a signal to the second user interface 106 and/or the ornament 102 to provide a notification and actuate the visual indicators 116 of the ornament 102 in a specific color scheme and/or pattern. For example, the color scheme and/or pattern for status one can be a slow change in coloring of the visual indicators 116 of the ornament 102 from red to green to white, indicating that the message has been sent to Santa Claus. As a further example, the color scheme and/or pattern for status two can be a solid green illumination of the visual indicators 116, indicating that Santa Claus has received and read the message. As a further example, the color scheme and/or pattern for status three can be a rapid blinking of the visual indicators 116 in all three colors, e.g., green, white, red, or the like, in no particular patterns, indicating that Santa Claus has responded to the child or has sent a message to all children in the family. As a further example, the color scheme and/or pattern for status five can be a slow changing of green to red and red to green, indicating that Santa Claus is delivering presents and getting closer to the house. As a further example, the color scheme and/or pattern for status six can be a flashing of green and red, indicating that Santa just flew over the house and has brought the present for the child. It should be understood that the color schemes and/or patterns described herein are exemplary and alternative color schemes and/or patterns can be used. In some embodiments, the first user interface 104 can permit the parent to customize the color schemes and/or patterns to be used for each status.

In some embodiments, the fourth tab 378 can be used to manually actuate or set a timer schedule for actuating the visual indicators 116 of the ornament 102 to indicate a proximity of Santa Claus to the house. In some embodiments, the fourth tab 378 can be used to manually set a position of Santa Claus at a position in the world. For example, if the user is located in New York City, the user can indicate on the fourth tab 378 that Santa Claus is currently in London, England. As the end of Christmas Eve approaches, the fourth tab 378 can be used to manually indicate that Santa Claus is slowly approaching New York City to deliver presents to those in New York City. In some embodiments, the fourth tab 378 indicate the position of Santa Claus based on the current time at the user's location. In particular, the interface of the fourth tab 378 can gradually change the position of Santa Claus closer to the user's location as the end of Christmas Eve approaches. In some embodiments, the interface provided by the fourth tab 378 can include an animated globe with an icon or indicator representing the position of Santa Claus.

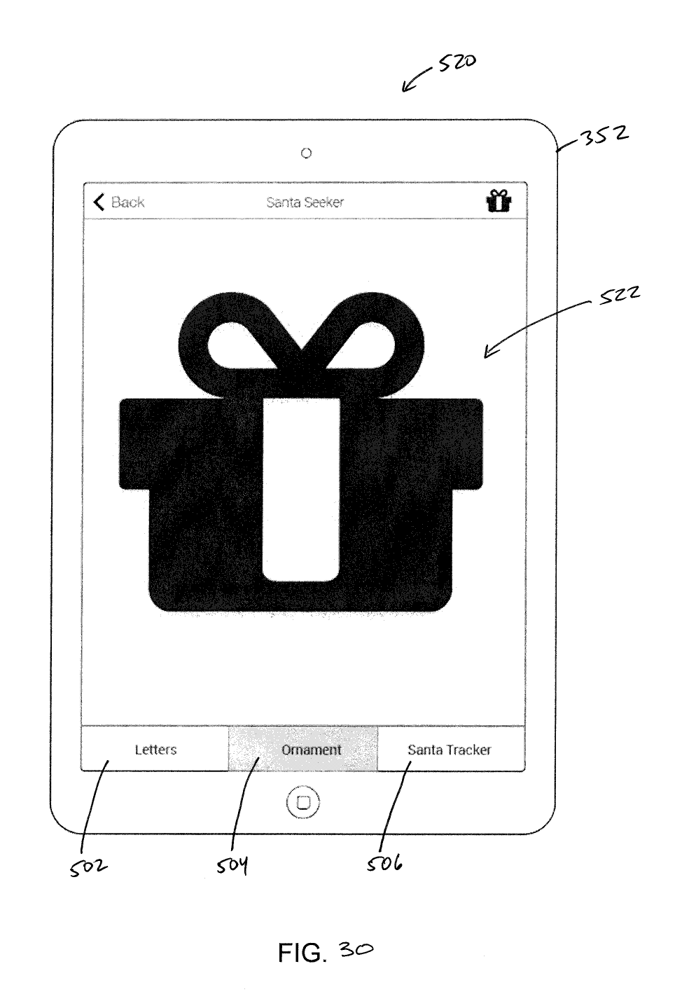

FIG. 29 is an exemplary graphical user interface window 500 of the system 100 in accordance with embodiments of the present disclosure. The window 450 can represent a child's interface via the second user interface 106. The second user interface 106 can therefore provide a system through which the child can communicate with Santa Claus during Christmas time via the child's application. Although illustrated as provided on the device 352, it should be understood that the second user interface 106 can be accessed for a variety of devices by logging into the application with the appropriate passcode.

The window 500 can include a messaging interface generated by the messaging engine 160. The messaging interface can include a first tab 502, a second tab 504, and a third tab 506. The first tab 502 can correspond to a messaging or letter interface, the second tab 504 can correspond to a gift or ornament interface, and the third tab 506 can correspond to a tracking interface. The messaging interface window 500 can include one or more messages 508 from Santa Claus, i.e., reply messages 442 (see FIG. 26) from the parent via the first user interface 104. The message 508 can be used to respond to the initial message 392 or subsequent messages sent by the child to Santa Claus. In some embodiments, the message 508 can be used to gather additional details about the requested gifts in order to narrow down the exact gift the child desires for Christmas. For example, the parent can ask the child through the message 508 what type of Frozen Doll the child would like. The window 500 includes a reply button 510 that can be used to generate and send a reply message to the parent via the messaging engine 160.

FIG. 30 is an exemplary graphical user interface window 520 of the system 100 in accordance with embodiments of the present disclosure. The window 520 can correspond to a selection of the second tab 504. The window 520 can include a notification section 522 that provides a notification to the child regarding a status of the gift and/or activity at the ornament 102. For example, the notification section 522 can provide a graphical representation of the ornament 102 if the visual indicators 116 of the ornament 102 are being illuminated or are about to be illuminated. In some embodiments, the illumination timing, color and/or pattern can coincide between the ornament 102 and the notifications provided to the child. As a further example, the notification section 522 can provide a graphical representation of a gift if the gift has been brought to the house. The child can go to the ornament 102 to visually receive feedback through the illumination scheme and/or pattern of the ornament 102 to determine what activity has occurred, e.g., the message from the child has been read, a reply message has been sent to the child, the gift is on its way to the child, Santa Claus is near the house, the gift has been delivered to the house, or the like.

The third tab 506 can be selected to determine the proximity or location of Santa Claus relative to the house. For example, the third tab 506 can provide a notification to the child if Santa Claus is approaching the house. The notifications provided to the child in the third tab 506 can be communicatively tied to the settings input by the parent through the fourth tab 378 of the first user interface 104. In some embodiments, the third tab 506 can provide an animation of a globe with an icon or indicator representing the position of Santa Claus in relation to the house. In some embodiments, the third tab 506 can also include an icon or indicator representing the user's current location or the location of the user's house. The user can thereby gradually track the position of Santa Claus as Santa Claus approaches the house to deliver presents.

The exemplary system 100 can thereby be used to interactively communicate with the child and provide feedback to the child regarding a status of the requested gifts and/or the proximity of Santa Claus to the house. Using the system 100, the parent can receive additional input regarding the desired gifts of the child and can use the first user interface 104 to browse and purchase the requested gifts in a convenient and efficient manner. The system 100 also provides an exciting and interactive experience for the child by providing the child an interface through which the child can communicate with Santa Claus and determine when the child's gift will be brought to the house. The interactive ornament 102 can thereby become a part of the daily routine of the child during Christmas time.

The system 100 can also provide another view for the parent into the child's life. For example, the parent can use the system 100 to learn more about what the child is or is not interested in. In particular, the child may reveal certain things to Santa Claus that are happening either in school or during the child's extracurricular activities that the child may choose not to share with the parents. The information shared by the child through the system 100 can therefore be important for both safety of the child, as well as relationship building with the child.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A method of interacting with an ornament, comprising:
establishing a communication network between an ornament, a first user interface including a first graphical user interface, and a second user interface including a second graphical user interface;
executing a messaging function at the second graphical user interface to generate and send a first message from the second user interface to the first user interface; and
upon sending the first message to the first user interface, transmitting a signal to the ornament to actuate a visual indicator of the ornament in a first color scheme or pattern to indicate that the first message has been sent to the first user interface.

2. The method of claim 1, comprising opening the first message at the first graphical user interface of the first user interface and transmitting a signal to the ornament to actuate the visual indicator of the ornament in a second color scheme or pattern.

3. The method of claim 1, comprising executing a messaging function at the first graphical user interface to generate and send a second message in response to the first message from the first user interface to the second user interface.

4. The method of claim 3, comprising, upon receiving the second message at the second user interface, transmitting a signal to the ornament to actuate the visual indicator of the ornament in a third color scheme or pattern to indicate that the second message has been received by the second user interface.

5. The method of claim 1, comprising executing a scheduling function that receives as input an indicator actuation preference, and that outputs a visual indicator actuation based on the indicator actuation preference.

6. The method of claim 5, wherein the indicator actuation preference is at least one of (i) a manual actuation of the visual indicator of the ornament or (ii) a timer schedule for actuation of the visual indicator of the ornament.

7. The method of claim 1, comprising executing a tracking function that receives as input an indicator actuation preference, and that outputs a visual indicator actuation of the visual indicator of the ornament in a fourth color scheme or pattern during a predetermined day and time specified in the indicator actuation preference.

8. The method of claim 1, comprising storing the first message in a messages database.

9. The method of claim 8, comprising constructing a database query to retrieve gift-related data from the messages database.

10. The method of claim 9, comprising executing a gift function that receives as input the gift-related data and that outputs a retailer link or advertisement for purchasing a product corresponding to the gift-related data.

11. The method of claim 10, comprising executing a data collection function that receives as input the gift-related data and that outputs a communication to at least one retailer or manufacturer including the gift-related data.

12. A non-transitory computer-readable medium storing instructions that are executable by a processing device, wherein execution of the instructions by the processing device causes the processing device to:
establish a communication network between an ornament, a first user interface including a first graphical user interface, and a second user interface including a second graphical user interface;
execute a messaging function at the second graphical user interface to generate and send a first message from the second user interface to the first user interface; and
upon sending the first message to the first user interface, transmit a signal to the ornament to actuate a visual indicator of the ornament in a first color scheme or pattern to indicate that the first message has been sent to the first user interface.

13. The medium of claim 12, wherein execution of the instructions by the processing device causes the processing device to transmit a signal to the ornament to actuate the visual indicator of the ornament in a second color scheme or pattern when the first message is opened at the first graphical user interface.

14. The medium of claim 12, wherein execution of the instructions by the processing device causes the processing device to execute a messaging function at the first graphical user interface to generate and send a second message in response to the first message from the first user interface to the second user interface, wherein upon receiving the second message at the second user interface, execution of the instructions by the processing device causes the processing device to transmit a signal to the ornament to actuate the visual indicator of the ornament in a third color scheme or pattern to indicate that the second message has been received by the second user interface.

15. The medium of claim 12, wherein execution of the instructions by the processing device causes the processing device to (i) store the first message in a messages database, (ii) construct a database query to retrieve gift-related data from the messages database, and (iii) execute a gift function that receives as input the gift-related data and that outputs a retailer link or advertisement for purchasing a product corresponding to the gift-related data.

16. A system of interacting with an ornament, the system comprising:
an ornament;
a first user interface including a first graphical user interface, a first non-transitory computer-readable medium, and a first processing device; and
a second user interface including a second graphical user interface, a second non-transitory computer-readable medium, and a second processing device, wherein the second processing device is configured to execute instructions stored in the second non-transitory computer-readable medium to:
establish a communication network between the ornament, the first user interface, and the second user interface;
execute a messaging function at the second graphical user interface to generate and send a first message from the second user interface to the first user interface; and
upon sending the first message to the first user interface, transmit a signal to the ornament to actuate a visual indicator of the ornament in a first color scheme or pattern to indicate that the first message has been sent to the first user interface.

17. The system of claim 16, wherein the first processing device is configured to execute instructions stored in the first non-transitory computer-readable medium to open the first message at the first graphical user interface of the first user interface, and, upon opening the first message at the first graphical user interface, transmit a signal to the ornament to actuate the visual indicator of the ornament in a second color scheme or pattern.

18. The system of claim 16, wherein the first processing device is configured to execute instructions stored in the first non-transitory computer-readable medium to execute a messaging function at the first graphical user interface to generate and send a second message in response to the first message from the first user interface to the second user interface, wherein upon receiving the second message at the second user interface, the second processing device is configured to execute instructions stored in the second non-transitory computer-readable medium to transmit a signal to the ornament to actuate the visual indicator of the ornament in a third color scheme or pattern to indicate that the second message has been received by the second user interface.

19. The system of claim 16, wherein the first processing device is configured to execute instructions stored in the first non-transitory computer-readable medium to (i) store the first message in a messages database, (ii) construct a database query to retrieve gift-related data from the messages database, and (iii) execute a gift function that receives as input the gift-related data and that outputs a retailer link or advertisement for purchasing a product corresponding to the gift-related data.

20. An ornament, comprising:
an ornament housing; and
a visual indicator disposed at least partially within the ornament housing;
wherein the visual indicator is configured to be actuated based on messages received or sent between a first user interface and a second user interface.
